(19) United States
(12) Patent Application Publication
(10) Pub. No.: US 2010/0047128 A1
(43) Pub. Date: Feb. 25, 2010

(54) LIQUID ASPIRATING APPARATUS AND SAMPLE ANALYZER

(75) Inventors: Kazunori MOTOTSU, Kobe-shi (JP); Toshihiro Ootani, Kobe-shi (JP); Hiroyasu Sumida, Ono-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 12/606,607

(22) Filed: Oct. 27, 2009

(30) Foreign Application Priority Data
Jun. 29, 2008 (JP) 2009-153252
Oct. 28, 2008 (JP) 2008-276947

(51) Int. Cl. B01J 19/00; B08B 3/00

(52) U.S. Cl. 422/63; 134/198

(57) ABSTRACT

The present invention is to present a liquid aspirating apparatus comprising: a liquid aspirating nozzle; an aspirator for aspirating liquid through the liquid aspirating nozzle; a washing liquid discharging nozzle being arranged along a longitudinal direction of the liquid aspirating nozzle, wherein a discharge hole for discharging washing liquid is formed on the washing liquid discharging nozzle and the discharge hole faces a side surface of the liquid aspirating nozzle; and a washing liquid supplier for supplying the washing liquid to the side surface of the liquid aspirating nozzle through the discharge hole of the washing liquid discharging nozzle.

### FIELD OF THE INVENTION

The present invention relates to a liquid aspirating apparatus and sample analyzer, and specifically relates to a liquid aspirating apparatus and sample analyzer provided with a liquid aspirating nozzle for aspirating liquid such as a sample, reagent and the like.

### BACKGROUND

Japanese Laid-Open Patent Publication No. 2005-283246, for example, discloses a conventional washing apparatus for washing a liquid aspirating nozzle which aspirates a liquid such as a blood sample, reagent and the like.

The nozzle washing apparatus disclosed in Japanese Laid-Open Patent Publication No. 2005-283246 is provided with an aspirating nozzle for aspirating a sample and a reagent, a discharging nozzle for discharging a washing solution, and a washing tank. The discharging nozzle of the nozzle washing apparatus disclosed in Japanese Laid-Open Patent Publication No. 2005-283246 is provided adjacently to the aspirating nozzle. The bottom end of the aspirating nozzle is also positioned below the bottom end of the discharging nozzle. A discharge hole for discharging the washing solution is provided on the bottom end of the discharging nozzle. This nozzle washing apparatus is configured so that the aspirating nozzle is lowered into the washing tank disposed below the aspirating nozzle, then washing solution is discharged from the discharging nozzle into the washing tank, and the aspirating nozzle is immersed in the washing solution within the washing tank to wash the exterior surface of the aspirating nozzle, and the interior surface of the aspirating nozzle is washed by aspirating the washing solution within the washing tank through the aspirating nozzle.

However, the washing of the exterior surface of the liquid aspirating nozzle is inadequate in the nozzle washing apparatus disclosed in Japanese Laid-Open Patent Publication No. 2005-283246.

### SUMMARY

A first aspect of the present invention is a liquid aspirating apparatus comprising:
a liquid aspirating nozzle;
an aspirator for aspirating liquid through the liquid aspirating nozzle;
a washing liquid discharging nozzle being arranged along a longitudinal direction of the liquid aspirating nozzle, wherein a discharge hole for discharging washing liquid is formed on the washing liquid discharging nozzle and the discharge hole faces a side surface of the liquid aspirating nozzle; and
a washing liquid supplier for supplying the washing liquid to the side surface of the liquid aspirating nozzle through the discharge hole of the washing liquid discharging nozzle.

A second aspect of the present invention is a sample analyzer comprising:
a sample aspirating apparatus for aspirating a sample in a container; and
an analyzing apparatus for analyzing a predetermined component in the sample in the container, using either the sample aspirated by the sample aspirating apparatus or the sample remaining in the container after aspiration by the sample aspirating apparatus, wherein
the sample aspirating apparatus comprises:
   a liquid aspirating nozzle for aspirating the sample in the container;
   an aspirator for aspirating the sample in the container through the liquid aspirating nozzle;
   a washing liquid discharging nozzle being arranged along a longitudinal direction of the liquid aspirating nozzle, a discharge hole for discharging washing liquid being formed on the washing discharging nozzle and the discharge hole facing a side surface of the liquid aspirating nozzle; and
   a washing liquid supplier for supplying the washing liquid to the side surface of the liquid aspirating nozzle through the discharge hole of the washing liquid discharging nozzle.

### BRIEF DESCRIPTION OF THE DRAWINGS

FIG. 1 is a top view showing the overall structure of an immunoassay analyzer of a first embodiment of the present invention;

FIG. 2 is a block diagram illustrating the structure of the immunoassay analyzer of the first embodiment shown in FIG. 1;

FIG. 3 is a block diagram illustrating the structure of the immunoassay analyzer of the first embodiment shown in FIG. 1;

FIG. 4 is a front elevation view the pipette tip used in the immunoassay analyzer of the first embodiment shown in FIG. 1;

FIG. 5 is a front elevation view the cuvette used in the immunoassay analyzer of the first embodiment shown in FIG. 1;

FIG. 6 is a perspective view of the first reactor of the immunoassay analyzer of the first embodiment shown in FIG. 1;

FIG. 7 is a perspective view of the BF separator of the immunoassay analyzer of the first embodiment shown in FIG. 1;

FIG. 8 is a side view of the BF separator of the immunoassay analyzer of the first embodiment shown in FIG. 1;

FIG. 9 is a perspective view of the washing unit of the BF separator of the immunoassay analyzer of the first embodiment shown in FIG. 1;

FIG. 10 is a cross sectional view of the washing unit of the BF separator of the immunoassay analyzer of the first embodiment shown in FIG. 1;

FIG. 11 is a cross sectional view illustrating the structure of the bottom side member of the washing unit of the BF separator of the immunoassay analyzer of the first embodiment shown in FIG. 1;

FIG. 12 is a cross sectional view illustrating the nozzle member and bottom side member of the washing unit of the BF separator of the immunoassay analyzer of the first embodiment shown in FIG. 1;

FIG. 13 is a perspective view showing the vicinity of the nozzle washing unit of the BF separator of the immunoassay analyzer of the first embodiment shown in FIG. 1;

FIG. 14 shows the measurement flow of the immunoassay analyzer of the first embodiment shown in FIG. 1;

FIG. 15 is a modal view of the reaction of the various reagents and antigen of the sample measured by the immunoassay analyzer of the first embodiment shown in FIG. 1;

FIG. 16 is a modal view illustrating the analysis operation of the BF separator of the immunoassay analyzer of the first embodiment shown in FIG. 1;

FIG. 17 is a modal view illustrating the analysis operation of the BF separator of the immunoassay analyzer of the first embodiment shown in FIG. 1;

FIG. 18 is a side view of the BF separator of the immunoassay analyzer of a second embodiment of the present invention;

FIG. 19 is a perspective view of the washing unit of the BF separator of the immunoassay analyzer of the second embodiment shown in FIG. 18;

FIG. 20 is an enlarged perspective view illustrating the aspirating nozzle and discharging nozzle of the washing unit of the immunoassay analyzer of the second embodiment shown in FIG. 19;

FIG. 21 is a top view showing the aspirating nozzle of the washing unit of the immunoassay analyzer of the second embodiment shown in FIG. 19;

FIG. 22 is a top view showing the discharging nozzle of the washing unit of the immunoassay analyzer of the second embodiment shown in FIG. 19;

FIG. 23 is a partial enlargement illustrating the side discharge hole of the discharge nozzle of the washing unit of the immunoassay analyzer of the second embodiment shown in FIG. 22;

FIG. 24 is a cross sectional view illustrating the aspirating nozzle and discharging nozzle of the washing unit of the immunoassay analyzer of the second embodiment shown in FIG. 19;

FIG. 25 illustrates the side discharge hole and the bottom discharge hole of the discharging nozzle of the washing unit of the immunoassay analyzer of the second embodiment shown in FIG. 22;

FIG. 26 illustrates the flow of the washing liquid discharged from the discharging nozzle of the washing unit of the immunoassay analyzer of the second embodiment shown in FIG. 19; and

FIG. 27 is a modal view from the bottom side of the aspirating nozzle and discharging nozzle illustrating the flow of the washing liquid discharged from the discharging nozzle of the washing unit of the immunoassay analyzer of the second embodiment shown in FIG. 26.

### DETAILED DESCRIPTION OF THE EMBODIMENT

The embodiments of the present invention are described hereinafter based on the drawings.

### First Embodiment

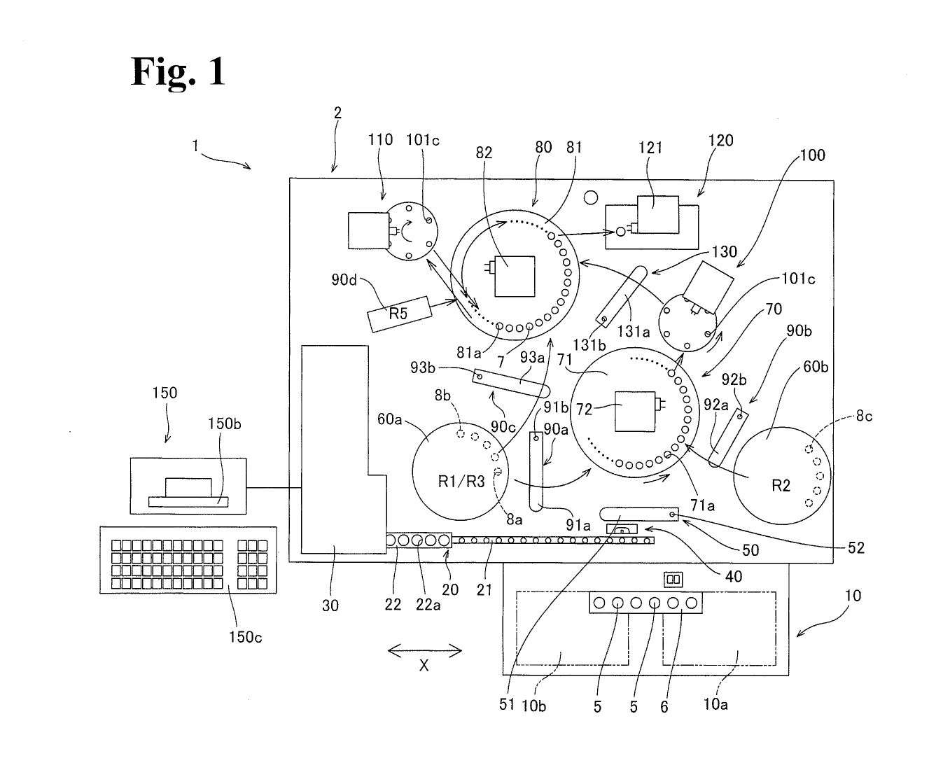

The general structure of the immunoassay analyzer 1 of the first embodiment of the present invention is first described below with reference to FIGS. 1 through 14.

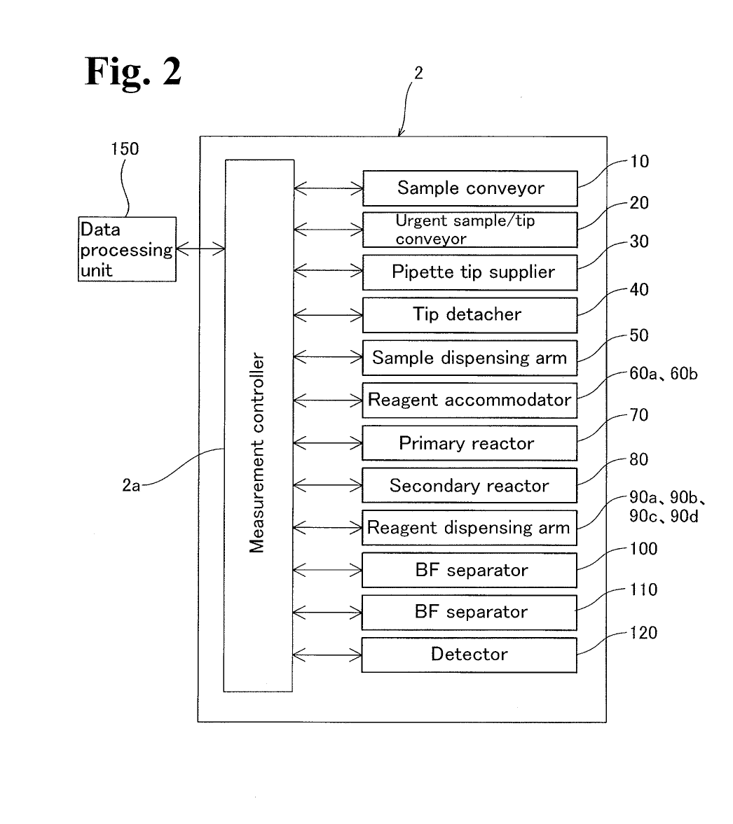

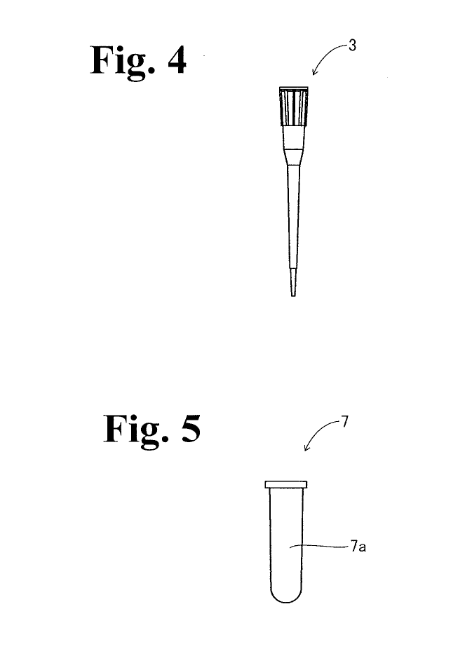

The immunoassay analyzer 1 of the first embodiment of the present invention is an apparatus for examining samples such as blood and the like for various items such as hepatitis B, hepatitis C, tumor markers, thyroid hormone and the like. As shown in FIG. 1, the immunoassay analyzer 1 is configured by a measuring unit 2 with the function of measuring sample blood, and a data processing unit 150 for analyzing the measurement results output from the measuring unit 2 and obtaining analysis results. The measuring unit 2 is mainly configured by a sample conveyor (sampler) 10, urgent sample/tip conveyor 20, pipette tip supplier 30, tip detacher 40, sample dispensing arm 50, reagent accommodators 60a and 60b, primary reactor 70 and secondary reactor 80, reagent dispensing arm 90, BF separators 100 and 110, and detector 120, as shown in FIGS. 1 and 2. Note that the immunoassay analyzer 1 of the first embodiment is configured so that the used pipette tip 3 (refer to FIG. 4) can be replaced each time a sample is aspirated and discharged in order to suppress contamination of one blood sample aspirated and discharged by the sample dispensing arm 50 with another sample.

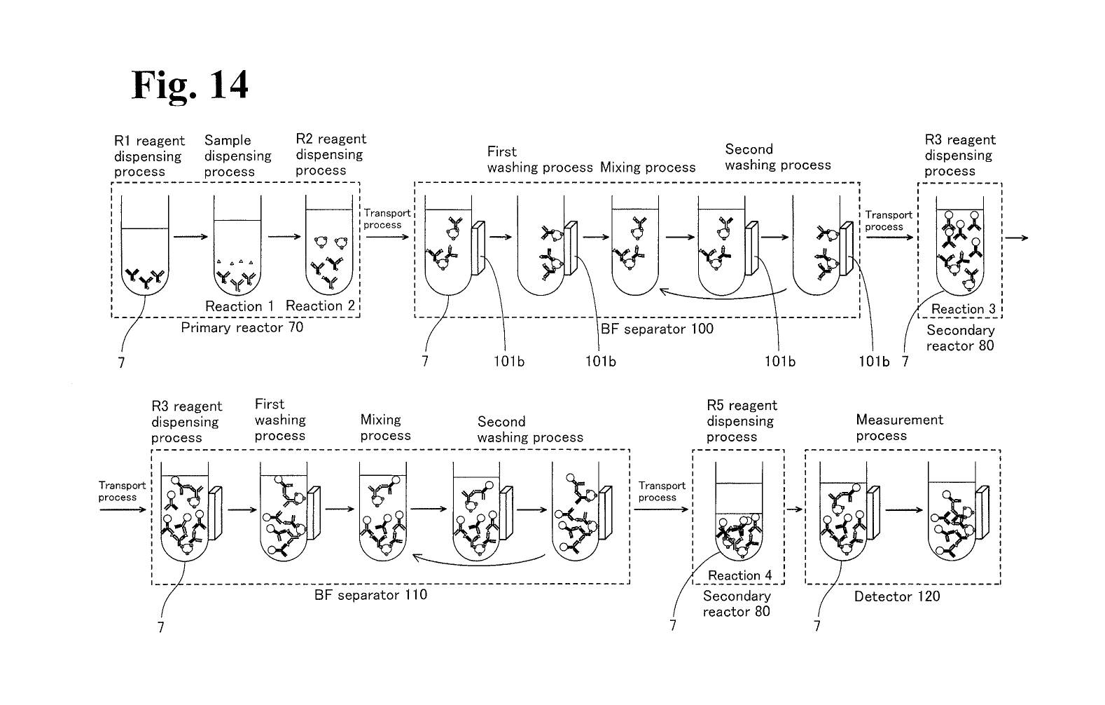

The immunoassay analyzer 1 is configured so as to remove an R1 reagent contained in unreacted (free) capture antibodies by first binding magnetic particles (R2 reagent) to a capture antibody (R1 reagent) bound to the antigen contained in a measurement object sample such as blood or the like, and thereafter attracting the magnetic particle and capture antibody complex to a magnet 101b (refer to FIG. 14) of the BF (BoundFree) separator 100. After the immunoassay analyzer 1 binds a marker antibody (R3 reagent) to the antigen bound to the magnetic particles, the R3 reagent which now includes unreacted (free) marker antibody is removed by attracting the antigen and marker antibody complex to the magnet of a BF separator 110. After a luminescent substrate (R5 reagent) which luminesces in a reaction process with the marker antibody has been added, the amount of light produced by the reaction between the marker antibody and the luminescent substrate is measured. Thus, the antigen bound to the marker antibody can be quantitatively measured through this process.

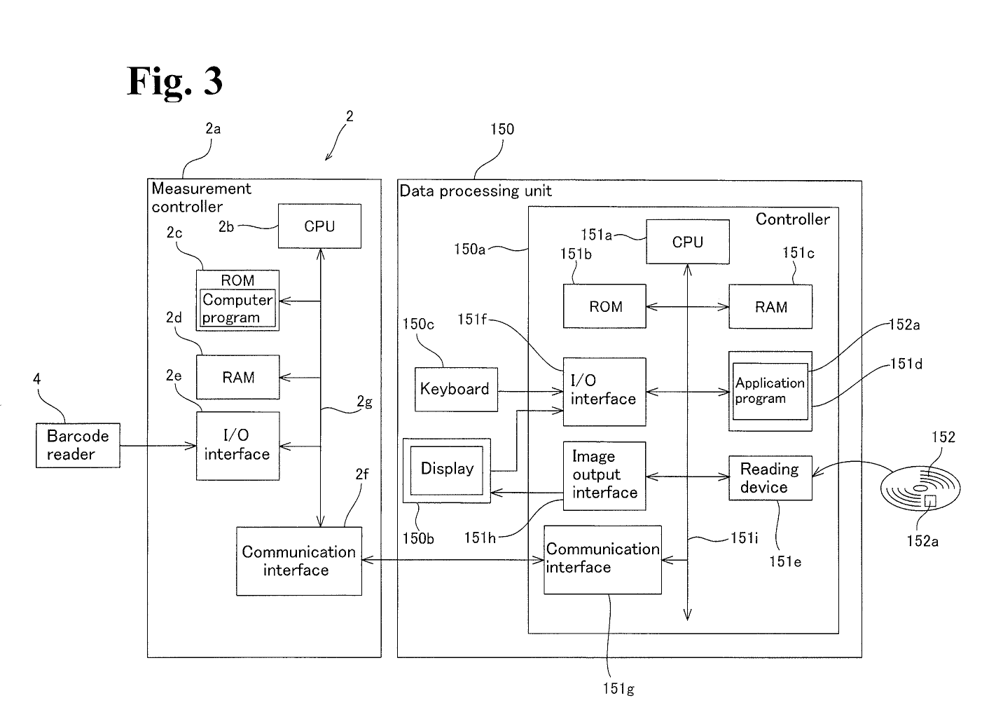

The mechanisms (each dispensing arm, BF separators 100 and 110 and the like) in the measuring unit 2 are controlled by a measurement controller 2a provided in the measuring unit 2, as shown in FIG. 3. Note that the dispensing arms, and BF separators 100 and 110 (refer to FIGS. 1 and 2) are described in detail later in conjunction with the descriptions of the structures of each unit.

The measurement controller 2a is mainly configured by a CPU 2b, ROM 2c, RAM 2d, input/output (I/O) interface 2e, and communication interface 2f. The CPU 2b, ROM 2c, RAM 2d, I/O interface 2e, and communication interface 2f are respectively connected by a bus 2g.

The CPU 2b is capable of executing computer programs loaded in the ROM 2c and computer programs read from the RAM 2d. The ROM 2c stores the computer programs executed by the CPU 2b, and data used in the execution of the computer programs. The RAM 2d is used as the work area of the CPU 2b when the CPU 2b reads the computer programs stored in the ROM 2c and executes the computer programs.

The I/O interface 2e may be a serial interface such as, for example, a USB, IEEE 1394, RS-232C or the like, a parallel interface such as a SCSI, IDE, IEEE 1284 or the like, and an analog interface configured by an D/A converter, A/D converter or the like. A barcode reader 4 is connected to the I/O interface 2e. Barcodes which record information identifying a sample within a test tube 5 and a rack 6 are respectively adhered to the test tube 5 and the rack 6 which carries a plurality of test tubes 5, and the barcode reader 4 has the function of reading the barcodes adhered to the test tubes 5 and the rack 6.

The communication interface 2f is, for example, an Ethernet (registered trademark) interface. The communication interface 2f is configured so as to be capable of sending and receiving data to/from the measurement controller 2b and the data processing unit 150 using a predetermined communication protocol.

The sample conveyor 10 is configured so as to transport the rack 6, which holds a plurality of test tubes 5 containing samples, to a position corresponding to the aspirating position of the sample dispensing arm 50, as shown in FIGS. 1 and 2. The sample conveyor 10 has a rack set 10a for placing the rack 6 which holds the test tubes 5 containing unprocessed sample, and a rack retainer 10b for retaining the rack 6 which holds the test tubes 5 containing dispensed and processed sample. The sample dispensing arm 50 aspirates the sample such as blood or the like within the test tube 5 by transporting the test tube 5 containing the unprocessed sample to a position corresponding to the aspirating position of the sample dispensing arm 50, whereupon the rack 6 holding the test tube 5 is retained in the rack retainer 10b.

The urgent sample/tip conveyor 20 is configured so as to interrupt the samples being transported by the sample conveyor 10 to transport a sample requiring urgent examination to the position of the sample dispensing arm 50. The urgent sample/tip conveyor 20 includes a slide rail 21 disposed so as to extend in the X direction, and a conveyor rack 22 which is movable along the slide rail 21. The conveyor rack 22 is provided with a tip accommodator 22a for mounting a test tube 4 which contains the urgent sample.

The pipette tip supplier 30 has the function of providing a free pipette tip 3 (refer to FIG. 4) one at a time to the tip accommodator 22a of the conveyor rack 22 of the urgent sample/tip conveyor 20. The tip detacher 40 (refer to FIG. 1) is provided to detach the pipette tip 3 (refer to FIG. 4) installed on the sample dispensing arm 50.

The sample dispensing arm 50 has the function of dispensing a sample in the test tube 5 delivered to the aspirating position by the sample conveyor 10 into a cuvette 7 (refer to FIG. 5) supported by a holder 71a of a rotatable table 71 of the primary reactor 70 which is described later. The sample dispensing arm 50 is configured so as to be capable of rotating an arm 51 on a shaft 52 and moving the arm 51 in vertical directions. A nozzle (not shown in the drawing) for aspirating and discharging sample is provided at the tip of the arm 51, and a pipette tip 3 (refer to FIG. 4) delivered by the conveyor rack 22 of the urgent sample/tip conveyor 20 is installed on the tip of the nozzle (not shown in the drawing).

A reagent accommodator 60a is configured so as to accept a reagent bottle 8a (refer to FIG. 1) for accommodating R1 reagent that contains capture antibody, and a reagent bottle 8b (refer to FIG. 1) for accommodating R3 reagent that contains marker antibody. The reagent accommodator 60a is also configured so as to be rotatable to respectively transport the installed reagent bottle 8a and the reagent bottle 8b to predetermined positions.

A reagent accommodator 60b is configured to accommodate a reagent bottle 8c (refer to FIG. 1) for accommodating R2 reagent that contains magnetic particles. The reagent accommodator 60b is also configured so as to be rotatable to transport the installed reagent bottle 8c to predetermined positions.

1 The primary reactor 70 is provided for rotating the cuvette 7, which is held by the holder 71a of the rotatable table 71, at a predetermined angle at a predetermined time period, and mixing the sample, R1 reagent and R2 reagent within the cuvette 7. That is, the primary reactor 70 is provided for reacting the antigen in the sample and the R2 reagent which has magnetic particles within the cuvette 7. The primary reactor 70 is configured by a rotating table 71 for transporting the cuvette 7 containing the sample, R1 reagent and R2 reagent in a rotational direction, and a container conveyor 72 for mixing the sample, R1 reagent and R2 reagent in the cuvette 7 and transporting the cuvette 7 containing the mixed sample, R1 reagent and 2 reagent to the BF separator 100.

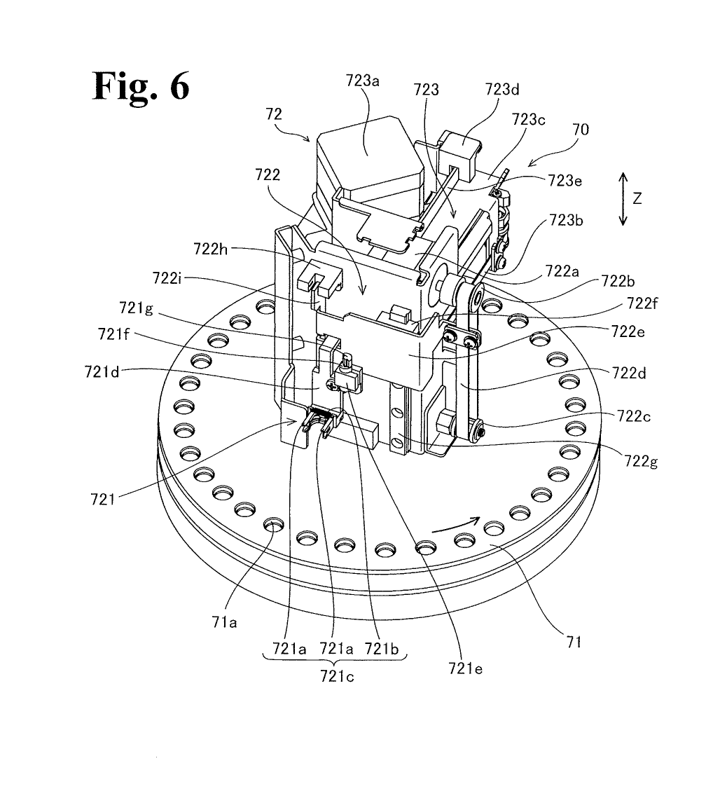

The container conveyor 72 is installed to be rotatable about the rotating table 71. The container conveyor 72 has the function of gripping the cuvette 7 held by the holder 71a of the rotating table 71, and mixing the preparation in the cuvette 7. The container conveyor 72 also has the function of mixing the sample, R1 reagent and R2 reagent, and transporting the cuvette 7 containing the incubated preparation to the BF separator 100. As shown in FIG. 6, the container conveyor 72 is configured by a mixer 721 for holding and mixing the cuvette 7, a vertical moving mechanism 722 for moving the mixer 721 in vertical directions, and a forward-and-back moving mechanism 723 for moving the mixer 721 and vertical moving mechanism 722 from the center of the rotating table 71 to the outer side thereof.

The mixer 721 has a chuck 721c configured by a pair of plates 721a for holding the barrel 7a (refer to FIG. 5) of the cuvette 7 and a coil spring 721b looped around the pair of plates 721a, a support member 721d for supporting the chuck 721c, a motor 721f mounted on a motor mount 721e integratedly provided on the support member 721d, and an eccentric weight 721g mounted on a shaft of the motor 721g so as to be rotatable. Therefore, the cuvette 7 disposed between the plates 721a of the chuck 721c is gripped via the force of the coil spring 721b. When the cuvette 7 is gripped by the chuck 721c, the sample in the cuvette 7 is mixed by actuating the motor 721f. Specifically, the eccentric weight 721g is rotated by the drive of the motor 721f so that the eccentric weight 721g and the motor 721f rotatingly vibrate. In this way the sample in the cuvette 7 is mixed since the vibration of the eccentric weight 721g and the motor 721f is transmitted to the cuvette 7 gripped in the chuck 721c.

The vertical moving mechanism 722 is provided on a movable member 723c of the forward-and-back moving mechanism 723, and is configured to be movable in the forward-and-back direction integratedly with the forward-and-back moving mechanism 723. The vertical moving mechanism 722 is configured by a motor 722a as a drive source, a pulley 722b connected to the motor 722a, a pulley 722c disposed at a predetermined spacing from the pulley 722b, a drive transmission belt 722d installed on the pulleys 722b and 722c, a moving member 722e linked to the drive transmission belt 722d, a direct drive guide configured by a sliding body 722f mounted on the moving member 722e slide rail 722g mounted on the forward-and-back moving mechanism 723 which is described later, and a light shield sensor 722h. A detection piece 722i is integratedly formed on the moving member 722e, and is detected by the light shield sensor 722h. The previously mentioned mixer 721 is mounted on the moving member 722e. Therefore, since the actuation of the motor 722a drives the drive transmission belt 722d via the pulley 722b, the moving member 722e which is linked to the drive transmission belt 722d is moved in a vertical direction (Z direction). Since the mixer 721 provided on the moving member 722e is thus moved in a vertical direction, the cuvette 7 gripped by the chuck 721c of the mixer 721 is also moved in a vertical direction.

The forward-and-back moving mechanism 723 is configured by a motor 723a as a drive source, a drive transmission belt 723b for transmitting the drive of the motor 723a, a moving member 723c linked to the drive transmission belt 723b, direct drive guide (not shown in the drawing) for moving the moving member 723c from the center of the rotating table 71 to the outer side thereof, and a light shield sensor 723d. A detection piece 723e is provided on the moving member 723c and is detected by the light shield sensor 723d. Therefore, since the actuation of the motor 723a drives the drive transmission belt 723b, the moving member 723c which is linked to the drive transmission belt 723b is moved in a forward-and-back direction. Since the vertical moving mechanism 722 provided on the moving member 723c is thus moved in a forward-and-back direction, the mixer 721 provided on the moving member 722e of the vertical moving mechanism 722 is also moved in a forward-and-back direction. is also moved in a vertical direction.

As shown in FIGS. 1 and 2, the reagent dispensing arm 90a has the functions of aspirating the R1 reagent in the reagent bottle 8a disposed on the reagent accommodator 60a, and dispensing the aspirated reagent R1 into the cuvette 7 into which the sample of the first reactor 70 was previously dispensed. The reagent dispensing arm 90a has the functions of rotating the arm 91a around a shaft 91b, and moving the arm 91a in vertical directions. A nozzle (not shown in the drawing) for aspirating and discharging R1 reagent in the reagent bottle 8a is mounted on the tip of the arm 91a, and after the nozzle aspirates the R1 reagent in the reagent bottle 8a, the R1 reagent is discharged into the cuvette 7 containing the previously dispensed sample.

The reagent dispensing arm 90b has the function of dispensing the R2 reagent in the reagent bottle 8c placed on the reagent accommodator 60b into the cuvette 7 of the primary reactor 70 into which the sample and R1 reagent have previously been dispensed. The reagent dispensing arm 90b has the functions of rotating the arm 92a around a shaft 92b, and moving the arm 92a in vertical directions. A nozzle (not shown in the drawing) for aspirating and discharging R2 reagent in the reagent bottle 8a is also provided on the tip of the arm 92a, and the R2 reagent in the reagent bottle 8c aspirated by this nozzle (not shown) is then dispensed into the cuvette 7 into which the sample was previously dispensed.

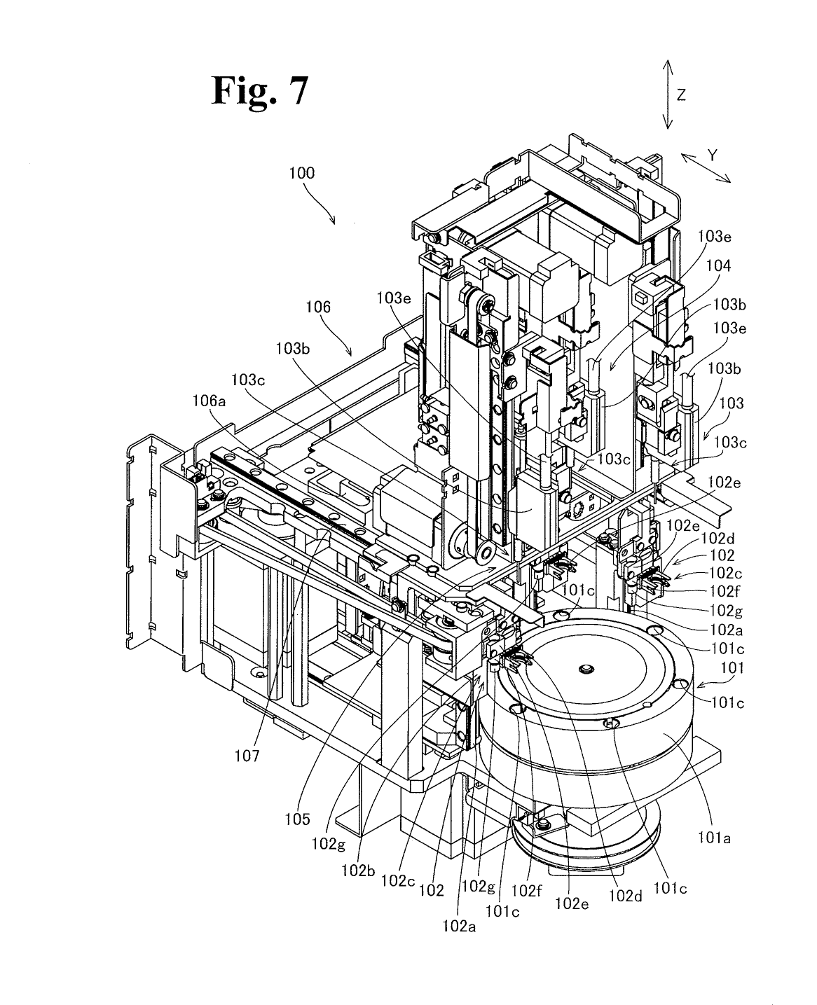

The BF separator 100 is provided to separate the magnetic particles and the free R1 reagent (unnecessary component) from the preparation in the cuvette 7 (refer to FIG. 5) transported by the container conveyor 72 of the primary reactor 70. In the first embodiment, the BF separator 100 is configured so as to remove the free R1 reagent (unnecessary component) in the cuvette 7 through the four cleaning processes, and separate the magnetic particles and free R1 reagent (unnecessary component). As shown in FIG. 7, the BF separator 100 includes a magnetic collector 101 for positioning and transporting the cuvette 7 in the rotation direction, four mixing mechanisms 102 (three of which are shown in the drawing) for mixing the preparation in the cuvette 7, a first separation mechanism 103 for aspirating the preparation in the cuvette 7 and discharging washing liquid, second separation mechanism 104, third separation mechanism (not shown) and fourth separation mechanism 105, and a nozzle washer 106.

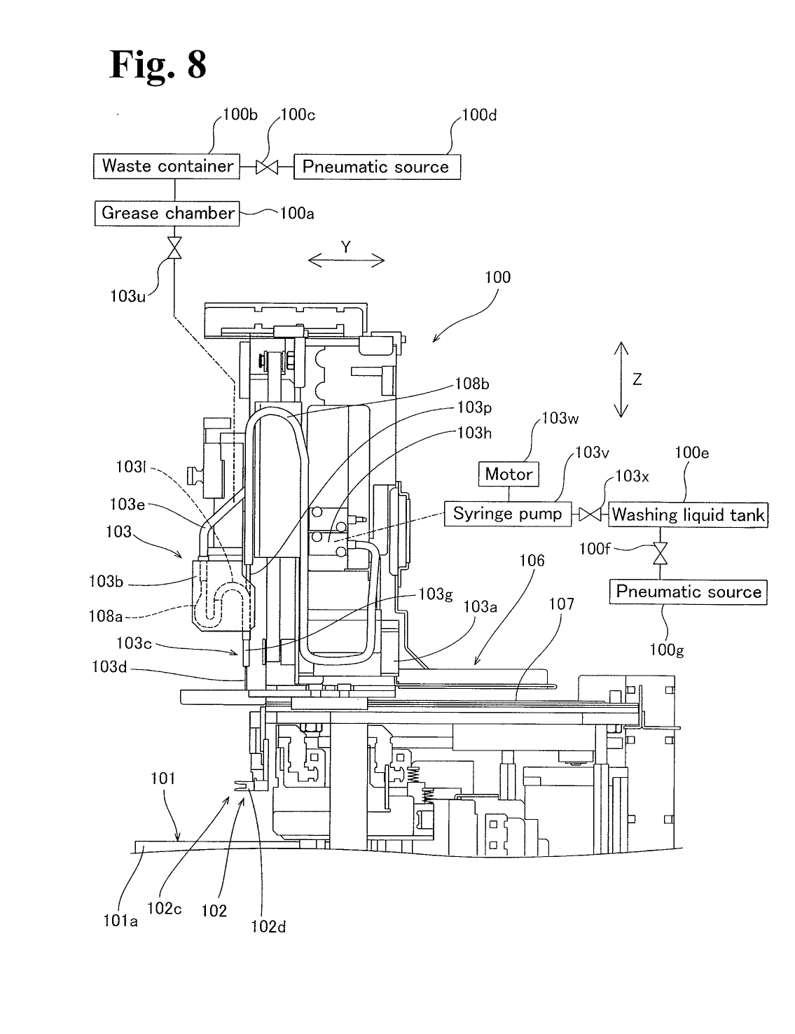

As shown in FIGS. 7 and 8, the BF separator 100 also includes a waste container 100b respectively connected, via a grease chamber 100a, to the first separation mechanism 103, second separation mechanism 104, third separation mechanism (not shown in the drawing) and fourth separation mechanism 105, and a pneumatic source 100d for switchably supplying a positive air pressure or negative air pressure by the operation of a valve 100c. The preparation and washing liquid in the cuvette 7 is respectively aspirated from the first separation mechanism 103, second separation mechanism 104, third separation mechanism (not shown in the drawing) and fourth separation mechanism 105 to the waste container 100b by the negative pressure supplied from the pneumatic source 100d. The grease chamber 100a has the function of removing the air (air bubbles) mixed in the aspirated preparation and washing liquid using a defoaming agent such as silicone grease or the like. The BF separator 100 further includes a washing liquid tank 100e respectively connected to the first separation mechanism 103, second separation mechanism 104, third separation mechanism (not shown in the drawing) and fourth separation mechanism 105, and a pneumatic source 100g for switchably supplying a positive air pressure or negative air pressure by the operation of a valve 100f.

Note that in the first embodiment the first separation mechanism 103 is provided for a first washing process performed in the cuvette 7, and the second separation mechanism is provided for a second washing process performed in the cuvette 7. The third separation mechanism (not shown in the drawing) is also provided for a third washing process performed in the cuvette 7, and the fourth separation mechanism is provided for a fourth washing process performed in the cuvette 7. That is, the first separation mechanism 103 is configured so as to separate unnecessary components focused on the large amount of unnecessary components in the cuvette 7, and the second separation mechanism 104 is configured so as to separate unnecessary components focused on the lesser amount of unnecessary components in the cuvette 7. The third separation mechanism (not shown in the drawing) is also configured so as to separate unnecessary components focused on a smaller amount of unnecessary components in the cuvette 7, and the fourth separation mechanism 105 is configured so as to separate unnecessary components focused on the small residual amount of unnecessary components remaining in the cuvette 7.

In the first embodiment, the magnetic collector 101 includes a rotatable mount 101a, and a magnet 101b (refer to FIG. 14) for magnetically collecting the magnetic particles in the cuvette 7. The mount 101a is provided with six cuvette insertion holes 101c at an angular spacing of approximately 60 degrees. The magnet 101b (refer to FIG. 14) is mounted within the mount 101a at a position on the side of the cuvette 7 disposed in the cuvette insertion hole 101c. In the first embodiment, the magnetic collector 101 is also capable of moving the cuvettes 7 disposed in the six cuvette insertion holes 101c to positions corresponding to the nozzle member 103d of the first separation mechanism 103, second separation mechanism 104, third separation mechanism (not shown in the drawing) and fourth separation mechanism 105 which are described later.

The four mixing mechanisms 102 are movable in the forward-and-back directions along the slide rail 107 which extends in the forward-and-back directions (Y direction). The mixing mechanisms 102 are respectively configured by a direct drive guide configured by slide rail 102a extending in the vertical direction (Z direction) and a slide body 102b, and a mixer 102c mounted on the slide body 102b. That is, each mixer 102c respectively moves integratedly in vertical directions along the slide rail 102a.

In the first embodiment, the mixer 102c has the function of mixing in a nonmagnetic collection state by lifting the cuvette 7 disposed in the cuvette insertion hole 101c of the magnetic collector 101. The mixer 102c includes a chuck 102d for gripping the cuvette 7, motor support 102e provided on the slide body 102b, motor 102f supported on the motor support 102e, and eccentric weight 102g mounted on the shaft of the motor 102f.

The first separation mechanism 103, second separation mechanism 104, third separation mechanism (not shown in the drawing) and fourth separation mechanism 105 are respectively movable in the forward-and-back directions along the slide rail 107 mentioned above. The first separation mechanism 103, second separation mechanism 104, third separation mechanism (not shown in the drawing) and fourth separation mechanism 105 are also respectively independently movable in vertical directions.

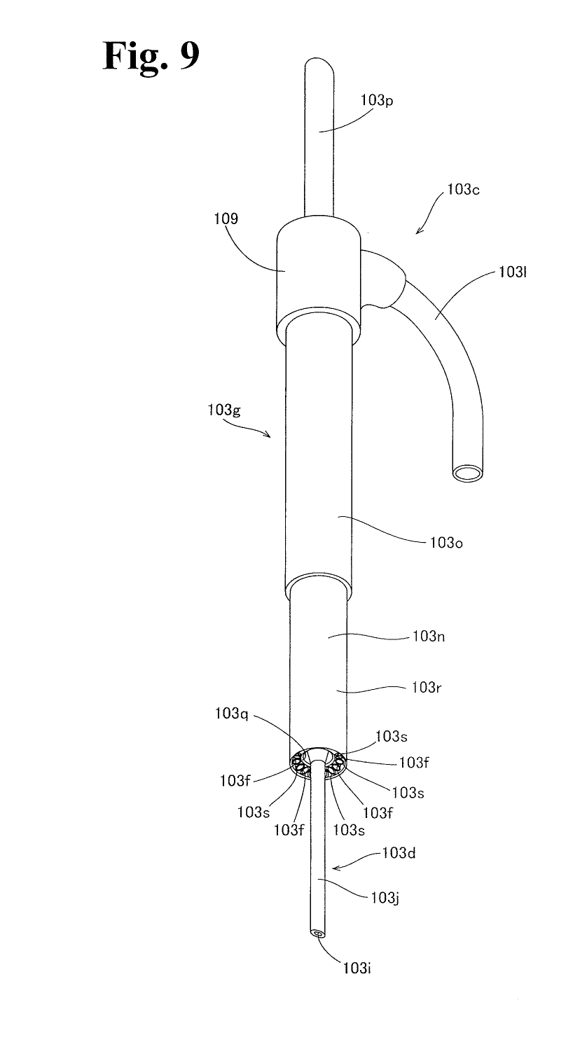

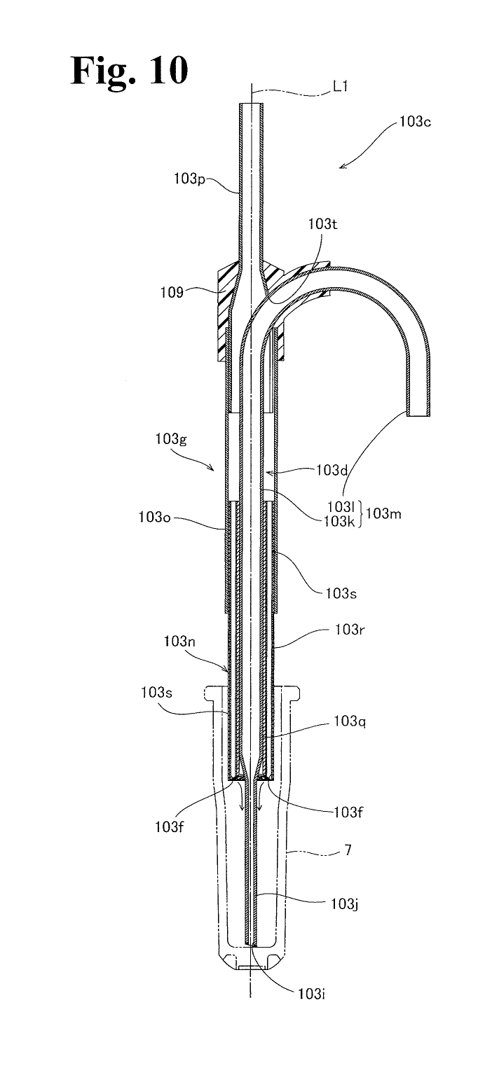

The first separation mechanism 103 includes a motor 103a (refer to FIG. 8), moving member 103b which moves in vertical directions in conjunction with the drive of the motor 103a, and a washer 103c provided on the moving member 103b. The washer 103c has the function of supplying and discharging the washing liquid to the cuvette 7 disposed in the cuvette insertion hole 101c of the magnetic collector 101. Specifically, in the first embodiment the washer 103c includes a nozzle member 103d for aspirating the unnecessary components contained in the cuvette 7 (refer to FIG. 10), as shown in FIGS. 9 and 10. As shown in FIG. 8, the nozzle member 103d is connected to the aspiration flow channel 103e through a hose 108a. The aspiration flow channel 103e is connected the grease chamber 100a through a valve 103u. The unnecessary components contained in the cuvette 7 (refer to FIG. 10) are aspirated by the nozzle member 103d via a negative pressure supplied from the pneumatic source 100d, and is delivered to the waste container 100b through the hose 108a, aspiration flow channel 103e, and grease tank 100a. The aspiration of the unnecessary components via the nozzle member 103d is accomplished by operating the valve 103u connected to the aspiration flow channel 103e and grease tank 100a, and the valve 100c provided between the pneumatic source 100d and the waste container 100b. The washer 103c also includes a jet member 103g for ejecting washing liquid from a plurality (18) of jets 103f which circumscribe the nozzle member 103d in a ring like manner. As shown in FIG. 8, the jet member 103g is connected to a valve 103h through a hose 108b. The valve 103h is connected to a syringe pump 103v which is driven by a motor 103w. The syringe pump 103v is also connected to the washing liquid tank 100e through a valve 103x. Washing liquid is supplied from the washing liquid tank 100e to the jet member 103g through the syringe pump 103v by controlling the operation of the valves 103h, 103x, and 100f and driving the motor 103w.

In the first embodiment, the nozzle member 103d has a nozzle 103j with an aspiration port 103i extending vertically that is immersed in the unnecessary component (liquid) in the cuvette 7, and an aspirating channel 103m which has a linear channel 103k connected to the top of the nozzle 103j for upwardly moving the upwardly flowing unnecessary component and a curved channel 103l that is curved to direct the upward flow of the unnecessary component downward, as shown in FIG. 10. Note that the nozzle member 103d is formed of stainless steel and has excellent anticorrosive properties.

The nozzle 103j has an internal diameter smaller than the linear channel 103k, and is formed so as to intersect the linear channel 103k of the aspiration channel 103m. In this way the unnecessary component aspirated by the nozzle 103j can not readily flow downward due to capillary action. The interior surface of the nozzle 103j is treated with a dispersion of fluorine resin plating so that the unnecessary component will not easily adhere to the interior surface of the nozzle 103j. The aspirating port 103i of the nozzle 103j is also cut so that the bottom end of the nozzle 103j is inclined relative to the longitudinal direction of the nozzle 103j. That is, the aspirating port 103i is shaped so that the bottom end of the nozzle 103j has a sharp tip, such that the sharp tip part of the bottom end of the nozzle 103j contacts the bottom surface of the cuvette 7 when the nozzle 103j has been inserted into the cuvette 7. In this way the unnecessary component of the cuvette 7 can be kept from remaining on the bottom surface of the cuvette 7. The curved channel 103l of the aspiration channel 103m has a U-shape extension at the top, which functions to suppress the unnecessary component which has passed the apex of the curved channel 103l from returning to the linear channel 103k side.

A hose 108a is connected to the curved channel 103l, as shown in FIG. 8, and the unnecessary component aspirated by the nozzle member 103d is aspirated to the aspiration channel 103e through the hose 108e.

In the first embodiment, the jet member 103g has a tubular shape with the same axis as the center axis L1 of the nozzle member 103d, as shown in FIG. 10. Specifically, the jet member 103g is configured by a bottom member 103n, middle member 103o, and top member 103p, and the bottom member 103n, middle member 103o, and top member 103p are respectively connected.

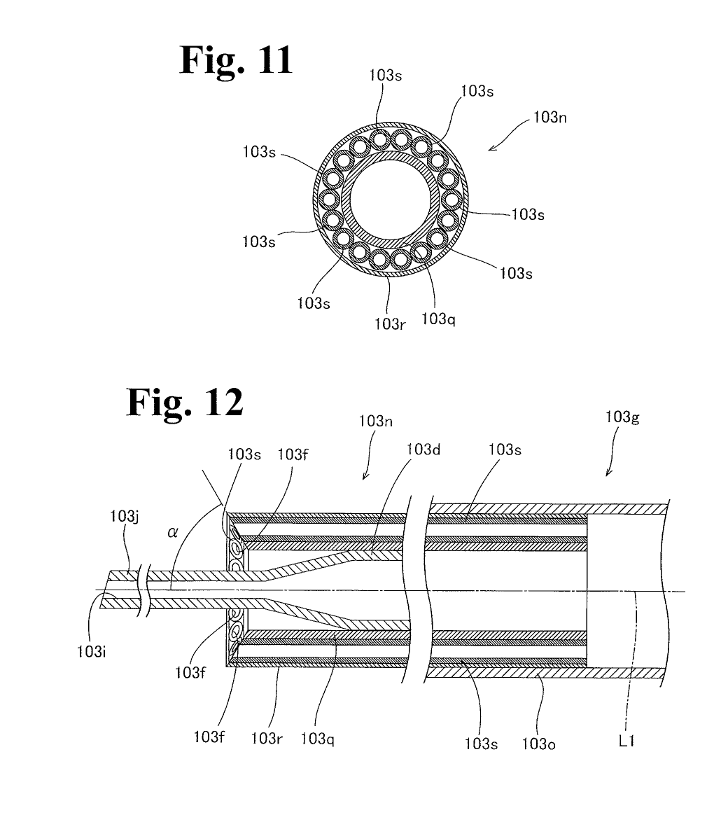

In the first embodiment, the bottom member 103n includes a circular inner member 103q, outer member 103r disposed at a predetermined spacing from the inner member 103q, and a plurality (18) of tubular members 103s disposed in a ring-like configuration between the inner member 103q and the outer member 103r, as shown in FIGS. 11 and 12. The inner member 103q, outer member 103r, and plurality of tubular members m103s respectively extend in the same direction as the nozzle member 103d extends (refer to FIG. 10), and the plurality of tubular members 103s form a ring around the circumference of the nozzle member 103d through the inner member 103q.

As shown in FIG. 12, each of the plurality of discharge holes 103f are an opening on the bottom end of the tubular member 103s in the first embodiment. The plurality of tubular members 103s are disposed in a ring-like configuration around the circumference of the nozzle member 103d in a mutually adhered state, and the discharge holes 103f at the bottom end of the plurality of tubular members 103s are mutually adhered similar to the tubular members 103s.

In the first embodiment, the endface of the bottom member 103n of the jet member 103g on which the plurality of discharge holes 103f are provided (bottom endface of the bottom member 103n) forms a concavity where the inner side where the nozzle member 103d is provided is higher (upstream side) than the outer side, as shown in FIGS. 10 and 12. Specifically, the bottom endface of the bottom member 103n is configured so that the side nearest the nozzle member 103d is positioned on the upstream side of the washing liquid flow with an inclination from the outer side of the bottom member 103n to the center axis L1 of the nozzle member 103d to position the side farthest from the nozzle member 103d on the downstream side of the washing liquid flow. The angle of inclination of the center axis L1 and the bottom endface of the bottom member 103n is a predetermined angle α (approximately 60 degrees (refer to FIG. 12)), and is adjusted so as to form an angle to eject the washing liquid discharged from the discharge hole 103f through the tubular member 103s toward the outer surface of the nozzle member 103d.

The middle member 103o is cylindrical, so that the outer part of the outer member 103r of the bottom member 103n is insertable, as shown in FIGS. 9 and 10. With the bottom member 103n inserted, the middle member 103o is fixedly attached to the bottom member 103n by the adhesion of the gap between the outer surface of the middle member 103o and the outer surface of the bottom member 103n.

The top member 103p is tubular in shape and contracts so that the top part has a smaller diameter than the bottom part. The top member 10p is inserted into the top side of the middle member 103o. A notch 103t is provided in the bottom part of the top member 103p, as shown in FIG. 10. In the first embodiment, the notch 103t is configured to allow the insertion of the curved channel 103l of the nozzle member 103d, and to guide the curved channel 103l of the nozzle member 103d from the inner part of the jet member 103g. Specifically, the curved channel 103l protrudes to the outer side of the jet member 103g from between the top end of the middle member 103o and the notch 103t of the top member 103p. A seal member 109 is provided in the gap between the notch 103t and the curved channel 103l, the gap between the top end of the middle member 103o and the curved channel 103l, and the gap between the middle member 103o and the top member 103p. In this way the washing liquid flowing through the top member 103p (jet member 103g) is prevented from leaking to the outside. The seal members 109 are formed of epoxy resin, and have the function of mutually anchoring in place the top member 103p, middle member 103o, and curved channel 103l as well as preventing leakage of the washing solution flowing through the top member 103p (jet member 103g) to the outside.

A hose 108b is connected to the top member 103p, as shown in FIG. 8, so that washing liquid supplied from the syringe pump 103v is delivered to the jet member 103g through the hose 108b.

The syringe pump 103v has the function of aspirating the washing liquid in the washing liquid tank 100e to the first separation mechanism 103 (syringe pump 103v) by driving the motor 103w, and the function of supplying the washing liquid aspirated into the syringe pump 103v to the jet member 103g at a predetermined pressure. Specifically, the valve 100f is opened and a positive pressure is supplied from the pneumatic source 100g to the washing liquid tank 1003; in this state the washing liquid is aspirated from the washing liquid tank 100e into the syringe pump 103v by opening the valve 103x and driving the syringe pump 103v to the aspiration side using the motor 103w. When the syringe pump 103v is filled with the washing liquid, the washing liquid is supplied from the syringe pump 103v to the jet member 103g through the hose 108b by closing the valve 103x and opening the valve 103h and driving the syringe pump 103v to the discharge side using the motor 103w.

As shown in FIG. 10, a plurality of channels (tube members 103s) are provided for guiding the washing liquid supplied from the syringe pump 103v (refer to FIG. 8) to the discharge holes 103f via the structure of the jet member 103g, and a single channel (middle member 103o and top member 103p) is provided for guiding the washing solution supplied from the syringe pump 103v to each channel (tube members 103s) via the connection to the top of the plurality of channels.

In the first embodiment, the second separation mechanism 104, third separation mechanism (not shown in the drawing), and the fourth separation mechanism 105 have the same structure as the first separation mechanism 103, and the washer 103c (refer to FIGS. 9 and 10) has the same structure as the washer 103c of the first separation mechanism 103, as shown in FIG. 7.

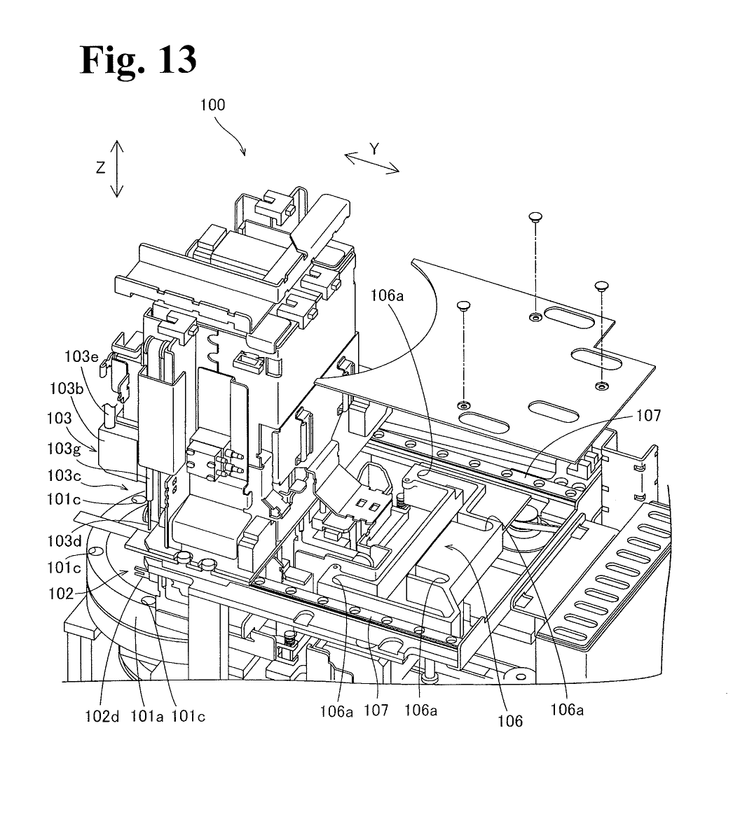

The nozzle washer 106 is provided for washing the nozzle members 103d of the first separation mechanism 103, the second separation mechanism 104, third separation mechanism (not shown in the drawing), and the fourth separation mechanism 105, as shown in FIG. 13. Specifically, the nozzle washer 106 is provided behind the magnetic collector 101, and has a hole 106a for the insertion of each nozzle member 103d. The nozzle member 103d is respectively movable in forward-and-back directions along the slide rail 107, and is moved to the nozzle washer 106 after the unnecessary component has been aspirated from the cuvette 7 by the magnetic collector 101. After the nozzle member 103d has been moved and inserted into the hole 106a of the nozzle washer 106, the nozzle washer 106 is configured so as to receive and dispose of the washing liquid discharged from the discharge holes 103f (refer to FIG. 10) of the jet member 103g. In this way the unnecessary component composed of R1 reagent and sample adhered to the nozzle member 103d can be washed away by the washing liquid supplied from the syringe pump 103v (refer to FIG. 8). As a result, unnecessary component of a previous cuvette 7 is prevented from being taken in even when the nozzle member 103d is inserted into the next cuvette 7 (refer to FIG. 5). Note that in the first embodiment the nozzle member 103d is washed twice in the first and second separation mechanisms 103 and 104, and the nozzle member 103d is washed only once in the third separation mechanism (not shown) and fourth separation mechanism 105.

The cuvette 7 (refer to FIG. 5) of the magnetic collector 101 in the BF separator 100 from which the free R1 reagent and the like have been separated is then transported to the holder 81a of the rotating table 81 in the secondary reactor 80 by the conveyor mechanism 130. The conveyor mechanism 130 is configured so as to rotate an arm 131a, which has a cuvette gripper (not shown) at the tip, around a shaft 131b, and move in vertical directions.

The secondary reactor 80 has the same structure as the primary reactor 70, and is provided for rotatably moving the cuvette 7 held by the holder 81a of the rotating table 80 a predetermined angle at predetermined time periods, and mixing the sample, R1 reagent, R2 reagent, R3 reagent, and R5 reagent in the cuvette 7. That is, the secondary reactor 80 is provided for reacting the antigen in the sample with the R3 reagent with marker antibodies in the cuvette 7, and reacting the marker antibodies of the R3 reagent with the R5 reagent with the luminescent substrate. The secondary reactor 80 is configured by a rotating table 81 for transporting in a rotational direction the cuvettes 7 containing the sample, R1 reagent, R2 reagent, R3 reagent, and R5 reagent, and a container conveyor 82 for mixing the sample, R1 reagent, R2 reagent, R3 reagent, and R5 reagent within the cuvette 7 and transporting the cuvette 7 containing the mixed sample and the like to the previously mentioned BF separator 110. The container conveyor 82 also has the function of again transporting the cuvette 7 which has been processed by the BF separator 110 back to the holder 81a of the rotating table 81. Note that the detailed structure of the secondary reactor 80 is identical to that of the primary reactor 70 and further description is therefore omitted.

The reagent dispensing arm 90c as the functions of aspirating the R3 reagent in the reagent bottle 8b disposed in the reagent accommodator 60a, and dispensing the aspirated R3 reagent into the cuvette 7 containing the previously dispensed sample, R1 reagent, and R2 reagent of the secondary reactor 80. The reagent dispensing arm 90c is configured so as to rotate the arm 93a around a shaft 93b, and move the arm 93a in vertical directions. A nozzle (not shown) is mounted on the tip of the arm 93a for aspirating and discharging the R3 reagent in the reagent bottle 8b, and has the function of dispensing the R3 reagent aspirated in the cuvette 7 the reagent dispensing arm 90c containing the previously dispensed sample, R1 reagent and R2 reagent after the nozzle (not shown) has aspirated the R3 reagent in the reagent bottle 8b.

The BF separator 110 (refer to FIGS. 1 and 2) has the same structure as the BF separator 100, and is provided for separating the free R3 reagent (unnecessary component) and magnetic particles from the cuvette 7 (refer to FIG. 5) transported by the container conveyor 82 of the secondary reactor 80. Note that structural details of the BF separator 110 are identical to that of the BF separator 100, and further description is therefore omitted.

The R5 reagent dispensing arm 90d is capable of moving the nozzle (not shown) in vertical directions, and is provided for supplying (dispensing) the R5 reagent into the cuvette 7 held by the rotating table 81 of the secondary reactor 80.

The detector 120 is provided for measuring the amount of antigen contained in a sample by obtaining the amount of light produced in the reaction process between the luminescent substrate and the marker antibody bound to the antigen in the sample subjected to predetermined processing via a photomultiplier tube. The detector 120 is provided with a conveyor mechanism 121 for transporting, to the detector 120, a cuvette 7 (refer to FIG. 5) being held by the holder 81a of the rotating table 81 of the secondary reactor 80.

The structure of the data processing unit 150 is described below. The data processing unit 150 is a personal computer (PC), and includes a controller 150a (refer to FIG. 5) configured by a CPU, ROM, RAM and the like, and a display 150b (refer to FIGS. 1 and 3), and keyboard 150c (refer to FIGS. 1 and 3). The display 150b is provided for displaying analysis results and the like obtained by analyzing the digital signal data received from the measuring unit 2. As shown in FIG. 3, the controller 150a is mainly configured by a CPU 151a, ROM 151b, RAM 151c, hard disk 151d, reading device 151e, I/O interface 151f, communication interface 151g, and image output interface 151h. The CPU 151a, ROM 151b, RAM 151c, hard disk 151d, reading device 151e, I/O interface 151f, communication interface 151g, and image output interface 151h are respectively connected by a bus 151i.

The CPU 151a executes the computer programs stored in the ROM 151b, and the computer programs loaded in the RAM 151c. The computer 151 functions as the data processing unit 150 when the CPU 151a executes an application program 152a which is described later.

The ROM 151b is configured by a mask ROM, PROM, EPROM, EEPROM or the like, and records the computer programs to be executed by the CPU 151a as well as the data used by those computer programs.

The RAM 151c is configured by SRAM, DRAM or the like. The RAM 151c is used when reading the application program recorded in ROM 151b and on the hard disk 151d. The RAM 151c is also used as the work area of the CPU 151a when the CPU 151a executes computer programs.

The hard disk 151d stores an operating system, application programs and the like, and the various computer programs to be executed by the CPU 151a as well as the data used in the execution of the computer programs. The application program 152a used for immunoassays in the first embodiment is also installed on the hard disk 151d. The CPU 151a measures the amount of antibody or antigen in the measurement sample based on the amount of light (digital signal data) produced by the measurement sample received from the measuring unit 2 by executing the immunoassay application program 152a.

The reading device 151e is configured by a floppy disk drive, CD-ROM drive, DVD-ROM drive or the like, and is capable of reading computer programs and data recorded on a portable recording medium 152. The portable recording medium 152 stores the immunoassay application program 152a so that the CPU 151a can read the application program 152a from the portable recording medium 152, and install the analysis program 152a on the hard disk 151d.

Note that the analysis program 152a may not only be provided by the portable recording medium 152, the analysis program 152a may also provided over an electrical communication line from an external device which is connected to the controller 150a via the electrical communication line (either wireless or wired) so as to be capable of communication. For example, the analysis program 152a may be stored on the hard disk of a server computer on the Internet so that the CPU 150a can access the server computer, download the application program 152a, and install the application program 152a on the hard disk 151d.

A multitasking operating system such as Microsoft Windows (registered trademark of Microsoft Corporation, USA) may also be installed on the hard disk 151d. In the following description, the application program 152a of the first embodiment also operates on this operating system.

The I/O interface 151f is configured by a serial interface such as a USB, IEEE1394, RS232C or the like, parallel interface such as SCSI, IDE, IEEE1284 or the like, analog interface such as a D/A converter, A/D converter or the like. The keyboard 150c is connected to the I/O interface 151f so that a user may use the keyboard 150c to input data to the computer 151.

The communication interface 151g is, for example, an Ethernet (registered trademark) interface. The CPU 151a can send and receive data to and from the measuring unit 2 using a predetermined communication protocol through the communication interface 151g.

The image output interface 151h is connected to the display 150b which is configured by an LCD, CRT or the like, and outputs image signals corresponding to the image data from the CPU 151a to the display 150b. The display 150b displays images (screens) according to the input image signals. The display 150b displays buttons for issuing various instructions to the apparatus, and the apparatus performs the process corresponding to a button when the button is selected. In the display 150b, a user can perform operations such as starting and interrupting a measurement by the apparatus, setting for the apparatus, and instructions for replacing or removing reagents and the like. The display 150b is a touch panel display, and a user can select a button by touching the button displayed on the display 150b. The buttons may also be selected by using a mouse or the like (not shown) via a movable pointer.

The analysis operation of the immunoassay analyzer of the first embodiment of the present invention is described below with reference to FIGS. 1, 4 through 7, 9, 10, and 13 through 17.

(Cuvette Supplying Process)

The cuvette 7 (refer to FIG. 5) is first supplied to the holder 71a of the rotating table 71 of the primary reactor 70, as shown in FIG. 1.

(R1 Reagent Dispensing Process)

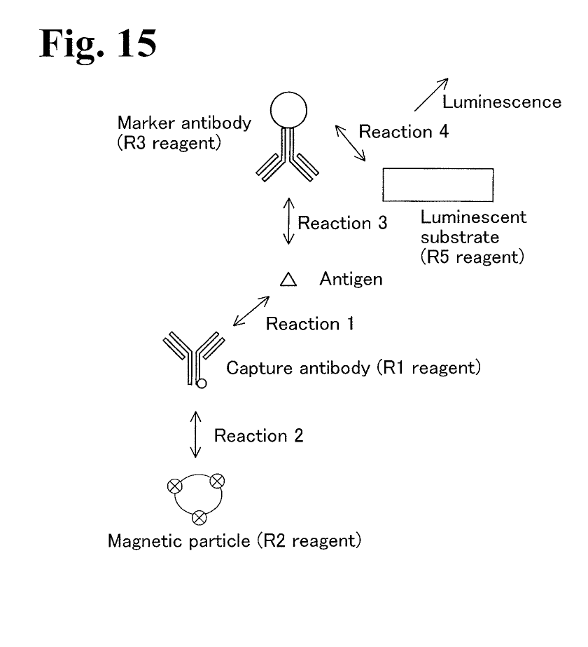

The reagent dispensing arm 90a aspirates the R1 reagent from the reagent bottle 8a disposed on the reagent accommodator 60a, then moves to the primary reactor 70 side, and discharges a predetermined amount of the aspirated R1 reagent into the cuvette 7. Note that the R1 reagent contains capture antibody for bonding to the antigen contained in a sample, as shown in FIGS. 14 and 15.

(Sample Dispensing Process)

After a pipette tip 3 (refer to FIG. 4) delivered by the conveyor rack 22 of the urgent sample/tip conveyor 20 has been installed, the sample dispensing arm 50 aspirates sample such as blood from the test tube 5 disposed in the rack 6 transported to the aspirating position by the sample conveyor 10. The sample dispensing arm 50 the rotates to the primary reactor 70 side, and discharges a predetermined amount of the aspirated sample into the cuvette 7 containing R1 reagent held in the holder 71a of the rotating table 71.

(R1 Reagent and Sample Mixing Process)

The container conveyor 72 of the primary reactor 70 shown in FIG. 6 then mixes the cuvette 7 containing the R1 reagent and the sample. Specifically, the chuck 721c of the mixer 721 is disposed so as to correspond to the cuvette 7 held by the holder 71a of the rotating table 71, and the mixer 721 of the container conveyor 72 is moved from the center to the outer side of the rotating table 71. In this way the cuvette 7 containing the R1 reagent and the sample is gripped by the chuck 721c of the mixer 721. After the chuck 721c holding the cuvette 7 has been raised by driving the motor 722a of the vertical moving mechanism 722, the motor 721f of the mixer 721 is actuated. In this way the R1 reagent and sample within the cuvette 7 are mixed since the rotational vibration of the motor 721f and eccentric weight 721g is transmitted to the sample and R1 reagent in the cuvette 7 held by the check 721c.

(Incubation Process (Reaction 1 Shown in FIGS. 14 and 15))

The mixed sample and R1 reagent is incubated for a predetermined time in the cuvette 7 held by the holder 71a of the rotating table 71, which rotates a predetermined angle. That is, the capture antibody (R1 reagent) binds to the antigen of the sample while the cuvette 7 is moved rotationally.

(R2 Reagent Dispensing Process)

The reagent dispensing arm 90b aspirates the R2 reagent in the reagent bottle 8c disposed at the reagent accommodator 60b, then discharges a predetermined amount of the aspirated R2 reagent into the cuvette 7 containing the sample and R1 reagent that have been incubated for the predetermined time. Note that the R2 reagent includes magnetic particles for binding to the capture antibody bound to the antigen in the sample, as shown in FIGS. 14 and 15.

(R2 Reagent and Sample Mixing Process)

The container conveyor 72 of the primary reactor 70 mixes the cuvette 7 containing the R1 reagent, R2 reagent, and the sample in an identical process to the previously described mixing process of the R1 reagent and the sample.

(Incubation Process (Reaction 2 Shown in FIGS. 14 and 15))

The mixed R1 reagent, R2 reagent and sample are incubated for a predetermined time in the cuvette 7 held by the holder 71a of the rotating table 71. That is, the magnetic particles (R2 reagent) are bound to the capture antibody (R1 reagent) bonded to the antigen of the sample during the rotational transport of the cuvette 7.

(Transport Process from Primary Reactor 70 to BF Separator 100)

The cuvette 7 containing the incubated R1 reagent, R2 reagent, and sample is transported to the cuvette insertion hole 101c of the BF separator 100 shown in FIG. 7 by the container conveyor 72 of the primary reactor 70. Specifically, the container conveyor 72 is rotated until the chuck 721c of the mixer 721 corresponds to the cuvette 7 which was rotationally transported during incubation, then the mixer 721 of the container conveyor 72 is moved from the center to the outer side of the rotating table 71. In this way the cuvette 7 containing the R1 reagent, R2 reagent, and sample is gripped by the chuck 721c of the mixer 721. After the check 721c holding the cuvette 7 is raised by driving the motor 722a of the vertical moving mechanism 722, the cuvette 7 is transported to the mount 101a of the magnetic collector 101 of the BF separator 100 by driving the motor 723a of the forward-and-back moving mechanism 723.

(First Washing Process of BF Separator 100)

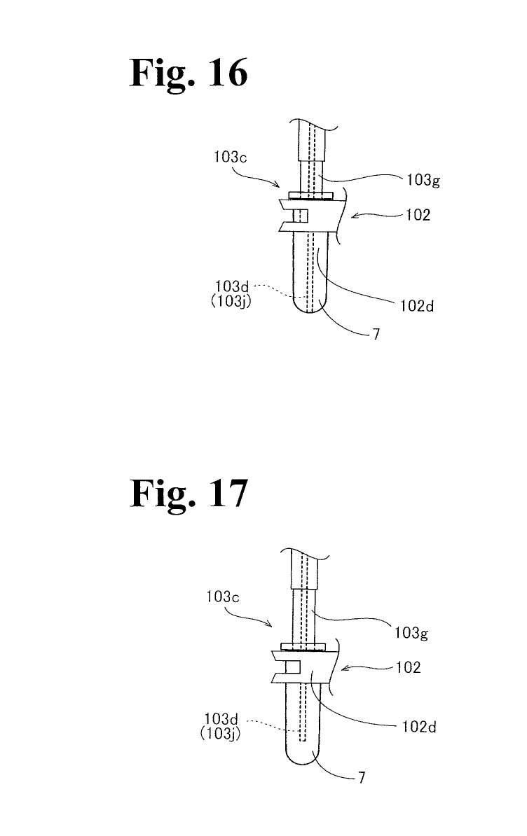

In the first embodiment, the cuvette 7, which is placed in the cuvette insertion hole 101c of the mount 101a of the magnetic collector 101, is then transported in a rotational direction in conjunction with the rotation of the mount 101a to a position corresponding to the mixer 102c of the mixing mechanism 102. As shown in FIG. 14, the magnetic particles in the cuvette 7 held in the insertion hole 101c of the mount 101a are collected by the magnet 101b disposed at the side of the cuvette 7. As shown in FIG. 7, the mixing mechanism 102 and the first separation mechanism 103 of the BF separator 100 are moved forward (Y direction) along the common slide rail 107, and the chuck 102d of the mixer 102c grips the cuvette 7. In this state, after inserting the nozzle member 103d of the washer 103c of the first separation mechanism 103 (refer to FIG. 7) into the cuvette 7, the preparation in the cuvette 7 is aspirated and the unnecessary components are removed by removing the magnetic particles and the antigen bonded to the capture antibody on the magnetic particles, as shown in FIG. 16. In the first washing process, however, part of the unnecessary components remain on the wall of the cuvette 7 together with magnetic particles attracted to the magnet 101b of the magnetic collector 101; therefore, in the first embodiment the mixing process and second washing process described below are performed to adequately remove the unnecessary components since it is difficult to adequately remove the unnecessary components by the first washing process.

(Mixing Process in BF Separator 100 (First))

In the first embodiment, washing liquid is supplied and mixed in the cuvette 7 in a first washing process in the BF separator 100. Specifically, in the first washing process immediately after aspiration by the nozzle member 103d of the first separation mechanism 103, a predetermined amount of the washing liquid is discharged from the discharge hole 103f of the jet member 103g of the first separation mechanism 103, as shown in FIG. 17. with the cuvette 7 is gripped in the chuck 102d of the mixer 102c, the mixer 102c is moved upward (Z direction) along the slide rail 102a (refer to FIG. 7). While the cuvette 7 is held, the motor 102f (refer to FIG. 7) is actuated and the rotational vibration of the motor 102f and the eccentric weight 102g (refer to FIG. 7 is transmitted to the cuvette 7 held in the chuck 102d to thereby mix the washing liquid, magnetic particles and unnecessary component in the cuvette 7. In this way the unnecessary component is remaining on the walls of the cuvette 7 is taken up with the magnetic particles and dispersed in the washing liquid.

As shown in FIG. 13, when mixing the materials in the cuvette 7, the first separation mechanism 103 moves the nozzle washer 106 at the back (Y direction) of the magnetic collector 101 upward along the slide rail 107 to wash the exterior of the nozzle member 103d. Specifically, after the first separation mechanism 103 has moved above the nozzle washer 106, the moving member 103b is moved downward in conjunction with the drive of the motor 103a (refer to FIG. 7). In this way the nozzle member 103d is inserted into the hole 106a of the nozzle washer 106. Thereafter, a predetermined amount of the washing liquid is discharged from the discharge hole 103f (refer to FIG. 9 of the jet member 103g so as to flow toward the outer surface of the nozzle member 103d, and the exterior surface part of the nozzle member 103d is washed by the discharged washing liquid flowing downward across the entire exterior surface of the nozzle member 103d. In this case, the bottom endface of the bottom member 103n (refer to FIG. 9) is inclined from the outer side of the bottom member 103n to the center axis L1 (refer to FIG. 10) of the nozzle member 103d so that the side nearest the nozzle member 103d is positioned on the upstream side of the flow of the washing liquid and the side farthest from the nozzle member 103d is positioned on the downstream side of the flow of the washing liquid, such that an even greater amount of the washing liquid is reliably discharged from the discharge hole 103f toward the outer surface of the nozzle member 103d. Note that the washing liquid washing the outer surface of the nozzle member 103d and flowing downward is discarded from the hole 106a of the nozzle washer 106.

In the first separation mechanism 103 of the first embodiment, the washing of the nozzle member 103d is controllably performed twice, so that after the washing liquid has been discharged from the discharge hole 103f of the jet member 103g, the washing liquid in the hole 106a of the nozzle washer 106 is again discharged from the discharge hole 103f of the jet member 103g. In this way the nozzle member 103d of the first separation mechanism 103 is washed twice in order to aspirate the high density unnecessary component of the free R1 reagent. Thereafter, the first separation mechanism 103 is moved to a position corresponding to the magnetic collector 101 along the slide rail 107. Note that in the nozzle member 103d washing process not only the first separation mechanism 103, but also the second separation mechanism 104 (refer to FIG. 7), third separation mechanism (not shown) and fourth separation mechanism 105 (refer to FIG. 7) simultaneously wash the nozzle member 103d.

(Second BF Separator 100 Washing Process (First))

As shown in FIG. 14, in the first embodiment the magnetic particles are collected at magnet 101b disposed at the side of the cuvette 7 by again holding cuvette 7, which has been mixed by the mixer 102c of the BF separator 100, in the insertion hole 101c of the magnetic collector 101. Then, the cuvette 7 that has been subjected to the first washing process is moved to a position corresponding to the second separation mechanism 104 by rotating the magnetic collector 101. That is, the second washing process is performed once by the second separation mechanism 104. As shown in FIG. 16, after the magnetic particles within the cuvette 7 have been magnetically collected, the washing liquid and unnecessary component are discarded. That is, after the nozzle member 103d of the washer 103c of the second separation mechanism 10-4 has been inserted into the cuvette 7, the residual unnecessary component collected by the magnetic particles can be removed by aspirating the washing liquid within the cuvette 7.

((Second) Mixing Process in BF Separator 100)

In the first embodiment, washing liquid is again supplied and mixed in the cuvette 7 in the first washing of a second washing process in the second separation mechanism 104 of the BF separator 100. Specifically, immediately after the washing liquid and unnecessary component have been aspirated by the nozzle member 103d of the second separation mechanism 104 in the first instance of the second washing process, a predetermined amount of washing liquid is discharged from the jet member 103g of the second separation mechanism 104, as shown in FIG. 17. The chuck 102d of the mixer 102c raises the cuvette 7, and the washing liquid and some residual unnecessary component and magnetic particles of the R1 reagent are mixed in the cuvette 7.

As shown in FIG. 13, when mixing the materials in the cuvette 7, the second separation mechanism 104 moves the nozzle washer 106 at the back (Y direction) of the magnetic collector 101 upward along the slide rail 107 to wash the exterior of the nozzle member 103d. In the second separation mechanism 104 of the first embodiment, similar to the first separation mechanism 103, the washing of the nozzle member 103d is controllably performed twice, such that after the washing liquid is discharged from the discharge hole 103f of the jet member 103g, the washing fluid in the hole 106a of the nozzle washer 106 is again discharged from the discharge hole 103f (refer to FIG. 9) of the jet member 103g. Thereafter, the second separation mechanism 104 is moved to a position corresponding to the magnetic collector 101 along the slide rail 107.

(Second BF Separator 100 Washing Process (Second))

As shown in FIG. 14, in the first embodiment the magnetic particles are collected at magnet 101b disposed at the side of the cuvette 7 by again holding cuvette 7, which has been mixed by the mixer 102c of the BF separator 100, in the insertion hole 101c of the magnetic collector 101. The cuvette 7 subjected to the (first instance) second washing process is moved to a position corresponding to the third separation mechanism (not shown) by rotating the magnetic collector 101. That is, a second instance of the second washing process is performed by the third separation mechanism (not shown). As shown in FIG. 16, after the magnetic particles within the cuvette 7 have been collected, the washing liquid and some residual unnecessary component is reliably removed. That is, after the nozzle member 103d of the washer 103c has been inserted into the cuvette 7, of the third separation mechanism (not shown) some residual unnecessary component can be reliably removed by aspirating the washing liquid in the cuvette 7.

((Third) Mixing Process in BF Separator 100)

In the first embodiment, washing liquid is again supplied and mixed in the cuvette 7 which has been subjected to the second washing process in the third separation mechanism (not shown) of the BF separator 100. Specifically, in the second instance of the second washing process, a predetermined amount of washing liquid is discharged by the jet member 103g of the second separation mechanism 104 immediately after the washing liquid and unnecessary component has been aspirated by the nozzle member 103d of the third separation mechanism (not shown), as shown in FIG. 17. The chuck 102d of the mixer 102c raises the cuvette 7, and the washing liquid and some residual unnecessary component and magnetic particles of the R1 reagent are mixed in the cuvette 7.

When mixing the material in the cuvette 7, the third separation mechanism (not shown) is moved above the nozzle washer 106 at the back (Y direction) of the magnetic collector 101 along the slide rail 107, and washes the outer surface of the nozzle member 103d. In the third separation mechanism (not shown) of the first embodiment, the washing of the nozzle member 103d is controllably performed only once, unlike the first separation mechanism 103. Thereafter, the third separation mechanism (not shown) is moved to a position corresponding to the magnetic collector 101 along the slide rail 107.

(Second BF Separator 100 Washing Process (Third))

As shown in FIG. 14, in the first embodiment the magnetic particles are collected at magnet 101b disposed at the side of the cuvette 7 by again holding cuvette 7, which has been mixed by the mixer 102c of the BF separator 100, in the insertion hole 101c of the magnetic collector 101. The cuvette 7 subjected to the (second instance) second washing process is moved to a position corresponding to the fourth separation mechanism 105 by rotating the magnetic collector 101. That is, the second washing process is performed a third time by the fourth separation mechanism 105. As shown in FIG. 16, after the magnetic particles in the cuvette 7 have been collected, the washing liquid in the cuvette 7 is aspirated, then washing liquid is again supplied into the cuvette 7 by the jet member 103g of the separation mechanism 104 similar to the second washing process (first and second instances). Thereafter, the cuvette 7 containing a preparation of mainly solid phase magnetic particles from which the unnecessary component has been removed is moved via the rotation of the mount 101a of the BF separator 100 to a position at which the cuvette 7 is gripped by the arm 131a of the conveyor mechanism 130, as shown in FIG. 1.

(Transport Process from BF Separator 100 to Secondary Reactor 80)

The cuvette 7 from which the magnetic particles and unnecessary component have been separated by the BF separator 100 is then held by the arm 131a of the conveyor mechanism 130 and moved to the holder 81a of the rotating table 81 of the secondary reactor 80.

(R3 Reagent Dispensing Process)

The reagent dispensing arm 90c then aspirates the R2 reagent in the reagent bottle 8b placed on the reagent accommodator 60a, then rotates to the secondary reactor 80 side and discharges a predetermined amount of R3 reagent into the cuvette 7 containing the antigen of the sample and the magnetic particles (R2 reagent) bonded thereto via the capture antibody (R1 reagent). Note that the R3 reagent includes marker antibody for bonding to the antigen in the sample, as shown in FIGS. 14 and 15.

(R3 Reagent and Sample Mixing Process)

The container conveyor 82 of the secondary reactor 80 then mixes the cuvette 7 containing the capture antibody (R1 reagent), antigen (sample), magnetic particles (R2 reagent), and the R3 reagent containing the marker antibody similar to the previously mentioned mixing process of the sample and the R1 reagent.

(Incubation Process (Reaction 3 Shown in FIGS. 14 and 15))

The mixed capture antibody (R1 reagent), antigen (sample), magnetic particles (R2 reagent), and the R3 reagent containing the marker antibody are incubated for a predetermined time in the cuvette 7 (refer to FIG. 4) at the holder 81a of the rotating table 81, as shown in FIG. 1. That is, the marker antibody (R3 reagent) is bound to the antigen previously bonded to the magnetic particles (R2 reagent) through the capture antibody (R1 reagent) while the cuvette is moved.

(Transport Process from Secondary Reactor 80 to BF Separator 110)

Then the cuvette 7 containing the incubated capture antibody (R1 reagent), antigen (sample), magnetic particles (R2 reagent), and the R3 reagent containing the marker antibody is moved to the insertion hole 101c of the BF separator 110 by the container conveyor 82 of the secondary reactor 80 similar to the previously mentioned transport process from the first reactor 70 to the BF separator 100.

(First Washing Process, Mixing Process, and Second Washing Process in BF Separator 110)

In the first embodiment, the first washing process, third mixing process, and second washing process in the BF separator 110 are performed similar to the previously described first washing process, third mixing process, and second washing process in the BF separator 100. In this way the R3 reagent containing the marker antibody that has not bonded to the antigen of the sample (unnecessary component) can be adequately removed. Thereafter, the cuvette 7 containing the preparation including the antigen bonded to the marker antibody from which the unnecessary component has been removed is moved in a rotational direction in conjunction with the rotation of the magnetic collector of the BF separator 110 to a position from which the cuvette 7 is transportable by the container conveyor 82 of the secondary reactor 80.

(Transport Process from BF Separator 100 to Secondary Reactor 80)

The cuvette 7, from which the unnecessary component and magnetic particles have been separated by the BF separator 110, is again moved to the holder 81a of the rotating table 80 by the container conveyor 82 of the secondary reactor 80.

(R5 Reagent Dispensing Process)

The R3 reagent dispensing arm 90d then discharges a predetermined amount of the R5 reagent containing a luminescent substrate from a reagent bottle (not shown in the drawing) placed at the bottom of the immunoassay analyzer 1 into the cuvette 7 containing the antigen of the sample, marker antibody (R3 reagent), magnetic particles (R2 reagent), and capture antibody (R1 reagent). Note that the R5 reagent includes a luminescent substrate for emitting light via a reaction with the marker antibody of the R3 reagent, as shown in FIGS. 14 and 15.

(R5 Reagent and Marker Antibody Mixing Process)

The container conveyor 82 of the secondary reactor 80 then mixes the cuvette 7 containing the capture antibody (R1 reagent), antigen (sample), magnetic particles (R2 reagent), marker antibody (R3 reagent), and R5 reagent containing the luminescent substrate similar to the previously mentioned mixing process of the sample and the R1 reagent.

(Incubation Process (Reaction 4 Shown in FIGS. 14 and 15))

Then the mixed capture antibody (R1 reagent), antigen (sample), magnetic particles (R2 reagent), marker antibody (R3 reagent), and R5 reagent containing the luminescent substrate are incubated for a predetermined time in the cuvette 7 while the cuvette 7 is held by the holder 81a of the rotating table 81. That is, the marker antibody (R3 reagent) and luminescent substrate (R5 reagent) are reacted while the cuvette 7 is moved rotationally.

(Measurement Process)

Thereafter, the cuvette 7 containing the incubated capture antibody (R1 reagent), antigen (sample), magnetic particles (R2 reagent), marker antibody (R3 reagent), and R5 reagent containing the luminescent substrate is moved to the mount by the conveyor mechanism 121 of the detector 120, as shown in FIGS. 1 and 2. The sample is then analyzed by obtaining the amount of luminescence produced by the reaction process of the R5 reagent luminescent substrate and the R3 reagent marker antibody via a photomultiplier tube (not shown) in the detector 120. The analysis operation performed by the immunoassay analyzer 1 of the first embodiment above is described below.

In the first embodiment, tubular members 103s are provided facing discharge holes 103f for discharging washing liquid provided on the exterior surface of the nozzle member 103d, and a syringe pump 103v is provided for supplying washing liquid to the exterior surface of the nozzle member 103d via the discharge holes 103f. In this way a larger amount of washing liquid can be reliably discharged to the exterior surface of the nozzle member 103d. Therefore, the exterior surface of the nozzle member 103d is more effectively washed.

In the first embodiment, the tubular members 103s can be easily provided facing the discharge holes 103f of the exterior surface of the nozzle member 103d by inclining the discharge holes 103f toward the exterior surface of the nozzle member 103d. A larger amount of washing liquid can be reliably discharged on the exterior surface of the nozzle member 103d by discharging the washing liquid from the discharge holes 103f that are inclined toward the exterior surface of the nozzle member 103d.

In the first embodiment as described above, a jet member 103g is provided which has a plurality of discharge holes 103f that circumscribe the nozzle member 103d in a ring-like manner, and washing liquid is supplied to the nozzle member 10o3d through the plurality of discharge holes 103f. In this way washing liquid discharged from the plurality of discharge holes 103f circumscribing the nozzle member 103d in a ring-like manner can flow over the entirety of the exterior surface of the nozzle member 103d. The exterior surface of the nozzle member 103d is therefore more effectively washed compared to when the discharge hole 103f is provided on only one side of the exterior surface of the nozzle member 103d. The jet member 103g with discharge holes 103f capable of discharging washing liquid toward the exterior surface of the nozzle member 103d is provided. In this way the exterior surface of the nozzle member 103d can be more effectively washed because the washing liquid reliably comes into contact with the exterior surface of the nozzle member 103d. Since the exterior surface of the nozzle member 103d is washed more effectively, the sample components adhered to the nozzle remember 103d can be prevented from contaminating the nest sample. Therefore, more precise measurement can be performed even when measuring minute components such as antigen and antibody in a sample.

In the first embodiment described above, the end surface of the jet member 103g provided with the plurality of discharge holes 103f is configured so that the inner side on the side provided with the nozzle member 103d is more concave on the upstream side of the liquid than the outer side. In this way the washing liquid discharged from the plurality of discharge holes 103f is directed toward the exterior surface of the nozzle member 103d since the plurality of discharge holes 103f face the exterior surface of the nozzle member 103d. Therefore, divergence of the washing liquid to parts other than the nozzle member 103d is suppressed and the washing liquid is reliably discharged on the exterior surface of the nozzle member 103d even when the discharge speed of the washing liquid is increased. Therefore, the washing process of the nozzle member 103d can be accelerated.

In the first embodiment described above, a plurality of discharge holes 103f and a plurality of tubular members 103s configuring the plurality of discharge holes 103f are mutually adhered. In this way the washing liquid uniformly washes the entirety of the exterior surface of the nozzle member 103d due to the small spacing between adjacent washing liquid jets discharged from the plurality of discharge holes 103f.

In the first embodiment described above, the plurality of tubular members 103s are provided in a ring shape in the longitudinal direction of the nozzle member 103d. In this way the washing liquid flowing through the plurality of tubular members 103s flows stably in the longitudinal direction of the nozzle member 103d via the plurality of tubular members 103s and the washing liquid can be discharged unidirectionally from the plurality of discharge holes 103f. In this way the washing liquid uniformly makes contact with the outer surface of the nozzle member 103d.

The first embodiment provides a plurality of flow channels (tubular members 103s) to direct the washing liquid supplied from the syringe pump 103v (refer to FIG. 8) to the discharge holes 103f, and a single flow channel (middle member 103o and top member 103p) to direct the washing liquid supplied from the syringe pump 103v to each flow channel (each tubular member 103s). According to this configuration, providing the single flow channel allows a reduced length of the tubular members 103s, thereby reducing the amount of material used to construct the tubular members 103s.

In the first embodiment described above, a nozzle 103j with an aspiration port 103i immersed in the liquid of a container is provided on the nozzle member 103d and extends vertically, and an aspiration flow channel is connected to the top end of the nozzle 103j and has a curved channel 103l which is curved to direct downward the washing liquid that flows upward from the nozzle 103j. In this way the liquid aspirated by the nozzle 103j is prevented from flowing back to the nozzle 103j because the liquid aspirated from the nozzle 103j flow downstream from the apex of the curve of the curved channel 103l.

In the first embodiment described above, the curved channel 103l of the nozzle member 103d extends from the inner part of the jet member 103g. In this way the leakage of the washing liquid passing through the inner part of the jet member 103g is prevented from the gap between the curved channel 103l and the jet member 103g. The seal member 109 configured of epoxy resin prevents corrosion compared to using a metal seal member top seal the gap between the curved channel 103l and the jet member 103g. Therefore, impurities can be prevented from contaminating the washing liquid as might occur if the seal member 109 became corroded.

### Second Embodiment

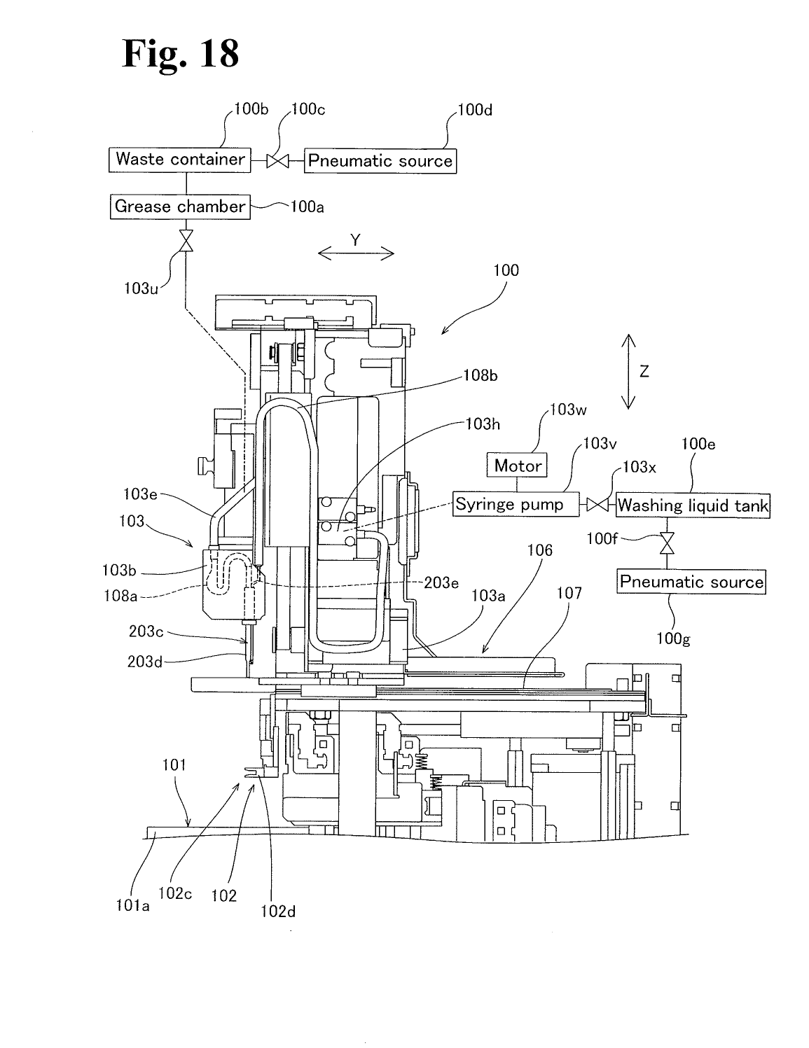

A second embodiment is described below with reference to FIGS. 18 through 25. The second embodiment differs from the first embodiment in the provision of the discharge holes 103f inclined relative to the nozzle member 103d, and is described by way of example in which side discharge holes 203l and 203m are provided at positions corresponding to an aspirating nozzle 203d on the side surface of a jet nozzle 203e.

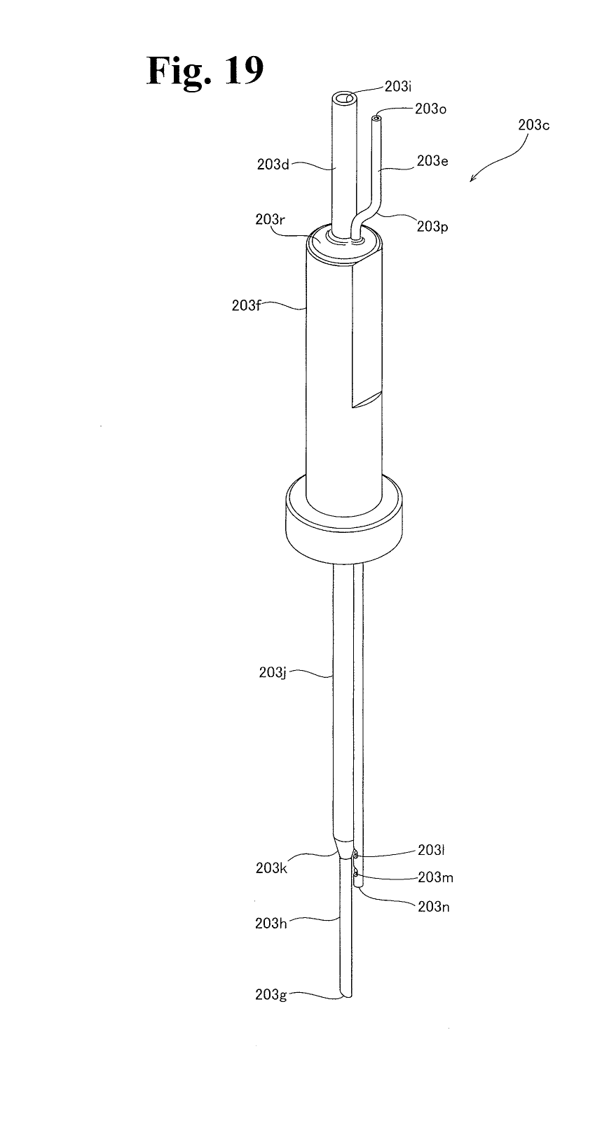

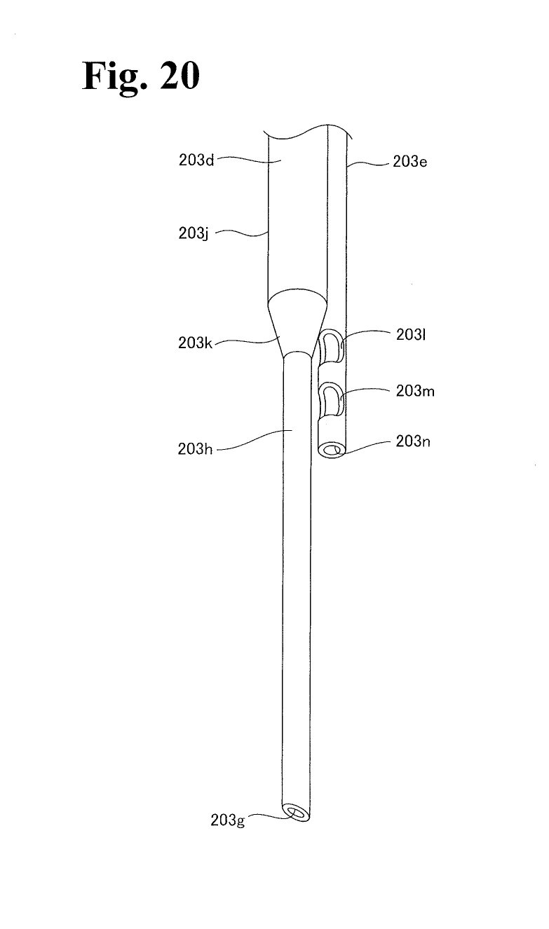

As shown in FIG. 18, in the second embodiment a washer 203c of the first separation mechanism 103 is provided with an aspirating nozzle 203d for aspirating unnecessary component contained in the cuvette 7 (refer to FIG. 10, an a jet nozzle 203e disposed along the longitudinal direction of the aspirating nozzle 203d and capable of discharging washing liquid from the side discharge holes 203l and 203m (refer to FIG. 19) and bottom discharge hole 203n (refer to FIG. 20) respectively. As shown in FIG. 18, the aspirating nozzle 203d is connected to the aspirating flow channel 103e through a hose 108a. The unnecessary components contained in the cuvette 7 (refer to FIG. 10) are aspirated by the nozzle member 203d via a negative pressure supplied from the pneumatic source 100d, and is delivered to the waste container 100b through the hose 108a, aspiration flow channel 103e, and grease tank 100a. The jet nozzle 203e is also connected to the valve 103h through a hose 108b. Washing liquid is supplied from the washing liquid tank 100e to the jet nozzle 203e through the syringe pump 103v by controlling the operation of the valves 103h, 103x, and 100f and driving the motor 103w. As shown in FIG. 19, the aspirating nozzle 203d and jet nozzle 203e are fixedly supported by a holder 203f.

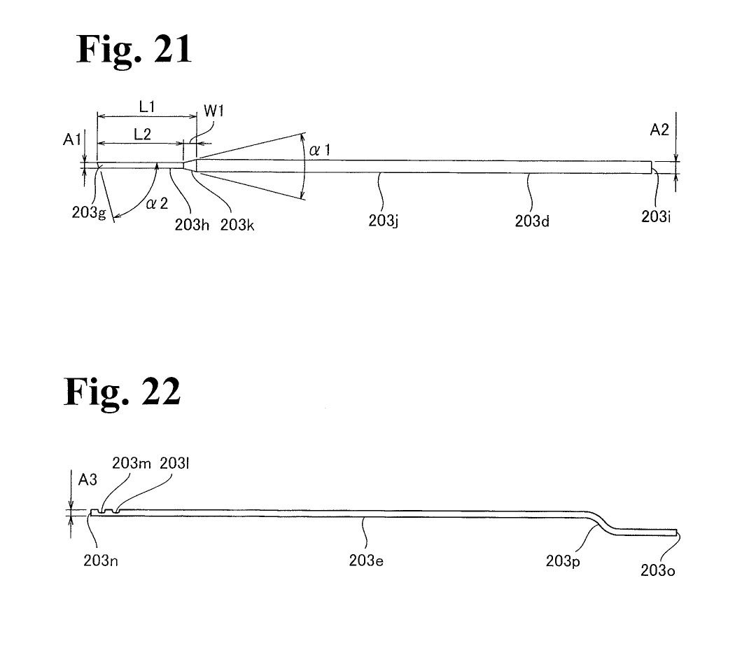

In the second embodiment, the aspirating nozzle 203d integratedly incorporates a first barrel 203h with an aspirating port 203g (refer to FIG. 20) for immersing in the unnecessary component (liquid) of the cuvette 7 and disposed so as to extend vertically, a second barrel 203j provided with a discharge port 203i at the top end, and a linkage 203k connecting the first barrel 203h and the second barrel 203j, as shown in FIG. 19. As shown in FIG. 21, the second barrel 203j has an outer diameter A2 (for example, approximately 2.11 mm) that is larger than the outer diameter A1 (for example, approximately 1 mm) of the first barrel 203h. The linkage 203k is configured so that the external diameter of the aspirating nozzle 203d continuously decreases from the second barrel 203j on the top side with the large external diameter A1 toward the first barrel 203h at the bottom side with the external diameter A1. More specifically, the linkage 203k is tapered as a reverse truncated cone inclined at an angle α1 symmetrical to the center axis. The linkage 203k is connected to the second barrel 203j at a position a distance L2 from the bottom end of the aspirating nozzle 203d, and connected to the first barrel 203h at a position a distance L2 from the bottom end of the aspirating nozzle 203d. That is, the inclined surface configured by the linkage 203k is formed in a region of width W1 from a position a distance L1 from the bottom end to a position a distance L2 from the bottom end on the exterior surface of the aspirating nozzle 203d.

The aspirating port 203g at the bottom end of the aspirating nozzle 203d (first barrel 203h) is formed in tip shape inclined at an angle α2. When the aspirating nozzle 203d has been inserted in the cuvette 7, the inclined tip part comes into contact with the bottom surface of the cuvette 7. In this way the unnecessary component of the cuvette 7 can be aspirated and kept from remaining on the bottom surface of the cuvette 7. Note that the aspirating nozzle 203d is formed of stainless steel for excellent anticorrosion properties.

As shown in FIG. 18, a hose 108a is connected to the discharge port 203i on the top end of the aspirating nozzle 203d (second barrel 203j), and the unnecessary component aspirated by the aspirating nozzle 203d is aspirated to the aspirating channel 103e through the hose 108a. The aspirated unnecessary component is then moved to the waste container 100b through the grease chamber 100a via a negative pressure supplied from the pneumatic source 100d.

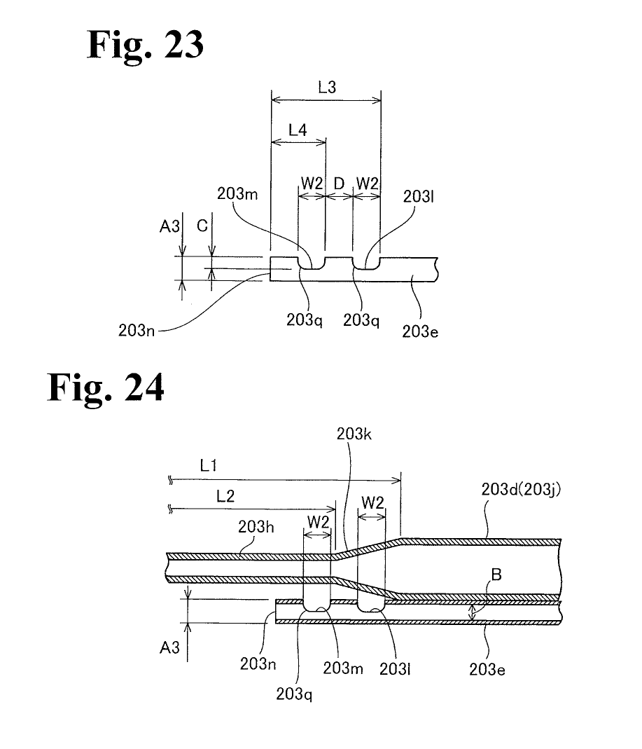

As shown in FIG. 22, the jet nozzle 203e has a cylindrical shape with an external diameter A3 (for example, about 0.88 mm) in the second embodiment. As shown in FIG. 19, a washing liquid inlet 203o is provided at the tip of the jet nozzle 203e, and a downward discharge hole 203n is provided at the bottom end of the jet nozzle 203e to discharge washing liquid in a downward direction. As shown in FIGS. 19 and 20, two side discharge holes 203l and 203m are formed facing perpendicular directions (the direction of disposition on the exterior surface of the aspirating nozzle 203d) relative to the longitudinal direction (vertical direction) of the jet nozzle 203e at positions on the side surface of the jet nozzle 203e corresponding to the exterior surface of the aspirating nozzle 203d. As shown in FIG. 23, the top side discharge hole 203l is formed so that the top end of the side discharge hole 203l is disposed at a position a distance L3 (for example, approximately 4 mm) from the bottom end of the jet nozzle 203e. The bottom side discharge hole 203m is formed so that the top end of the side discharge hole 203m is disposed at a position a distance L4 (for example, approximately 2 mm) from the bottom end of the jet nozzle 203e. The side discharge holes 203l and 203m are disposed linearly with a predetermined spacing D (for example, about 1 mm) therebetween along the longitudinal direction (vertical direction) of the jet nozzle 203e. Note that the jet nozzle 203e is formed of stainless steel similar to the aspirating nozzle 203d.

As shown in FIG. 24, the top side discharge hole 203l is disposed at a position corresponding to the external surface of the tapered linkage 203k of the aspirating nozzle 203d. The bottom side discharge hole 203m is disposed so as to correspond to the external surface of the first barrel 203h. The washing liquid therefore is discharged from the top side discharge hole 203l toward the tapered external surface of the linkage 203k, and discharged from the bottom side discharge hole 203m toward the external surface of the first barrel 203h.

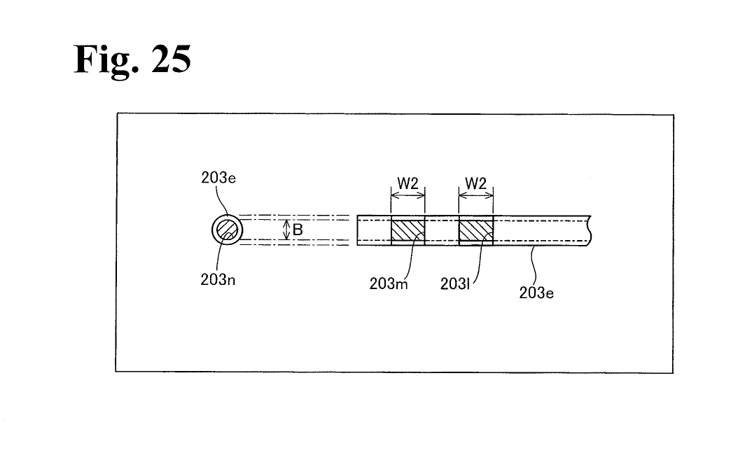

As shown in FIG. 23, the side discharge holes 203l and 203m are notched to a depth C (for example, approximately 0.44 mm) at the side surface of the jet nozzle 203e, and have mutually equal widths W2 (for example, approximately 1 mm). The depth C is about equal to half the external diameter A3 of the jet nozzle 203e in the second embodiment. The notched side discharge holes 203l and 203m and the corner 203q of port 203m are arc-shaped. In the second embodiment, the size of the openings of the side discharge holes 203l and 203m is larger than the size of the opening of the bottom discharge hole 203n. Specifically, the side discharge holes 203l and 203m have a depth C approximately half the external diameter A3 of the jet nozzle 203e, and the width in the latitudinal direction of the side discharge holes 203l and 203m is approximately equal to the internal diameter B (for example, about 0.58 mm) of the jet nozzle 203e, as shown in FIG. 25. The width W2 (approximately 1 mm) in the longitudinal direction of the side discharge holes 203l and 203m is greater than the internal diameter b (approximately 0.58 mm) of the jet nozzle 203e. Therefore, the size of the opening of the side discharge holes 203l and 203m (plane area viewed from the discharge direction) is such that (approx.) B×W2=(approx.) 0.58 mm. On the other hand, the size of the opening of the bottom discharge hole 203n is equal to a circular area of internal diameter B such that (n(B/2)²=(approx.)0.26 mm²). Therefore, the side discharge holes 203l (203m) have a larger discharge hole area than the bottom discharge hole 203n.

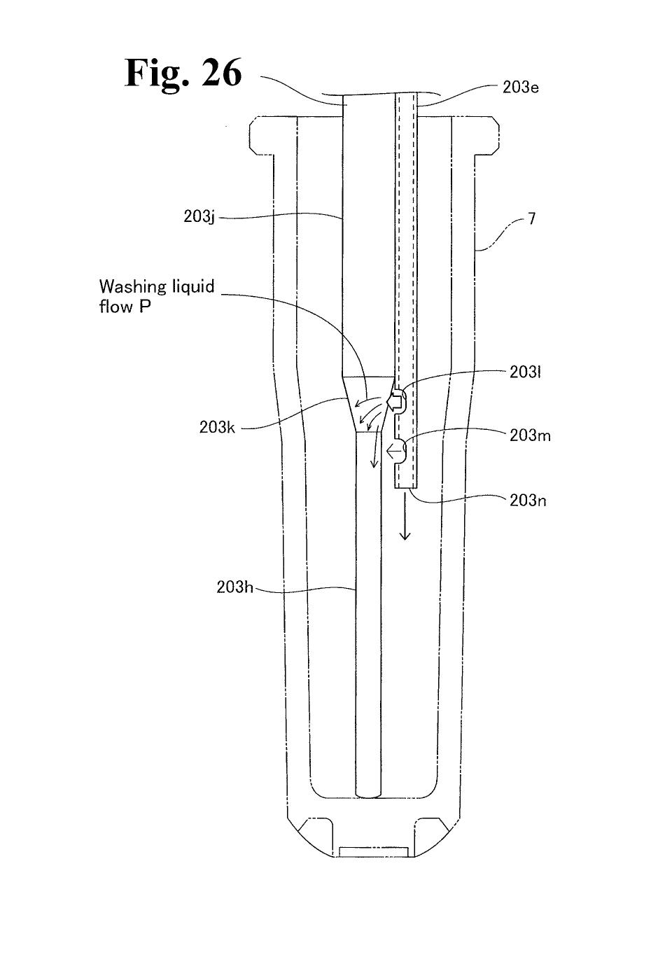

As shown in FIG. 18, the hose 108b is also connected to the top end of the jet nozzle 203e. Washing liquid supplied from the syringe pump 103v through the valve 103h is delivered into the jet nozzle 203e from the inlet 203o (refer to FIG. 19) via the hose 108b. The washing liquid inflowing from the inlet 203o passes through the curve 203p and is discharged from the side discharge holes 203l and 203m toward the aspirating nozzle 203d, and discharged downward from the bottom discharge hole 203n into the cuvette 7 (refer to FIG. 26).

The holder member 203f is cylindrical and provided with a through hole (not shown) for press-fitting the aspirating nozzle 203d and jet nozzle 203e. As shown in FIG. 19, the aspirating nozzle 203d and jet nozzle 203e are respectively press-fit in the through holes of the holder member 203f and fixedly attached by a coating of adhesive 203r on the top surface of the holder member 203f. In this way the components of the adhesive 203r are prevented from contaminating the inside of the cuvette 7 by fixedly attaching the aspirating nozzle 203d and jet nozzle 203e on the top surface side of the holder member 203f using the adhesive 203r.

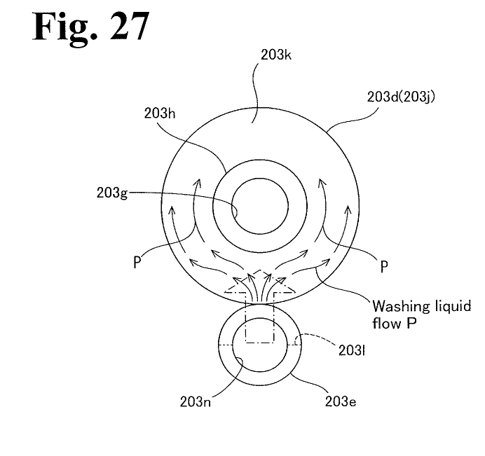

The flow of the washing liquid discharged from the jet nozzle 203e of the washer 203c in the second embodiment is described below with reference to FIGS. 26 and 27.

As shown in FIG. 26, the respective amounts of washing liquid discharged from the three discharge holes (side discharge holes 203l, 203m, and bottom discharge hole 203n) differ depending on the size of the opening and the difference in pressures of the washing liquid passing through the tubular channel of the jet nozzle 203e at each discharge hole. In the second embodiment, the largest amount of washing liquid is discharged from the top side discharge hole 203l which is the first release of the pressure of the washing liquid flowing downward from the inside the jet nozzle 203e, the next largest amount of washing liquid is discharged from the bottom discharge hole 203n, and the least amount of washing liquid is discharged from the bottom side discharge hole 203m.

The washing liquid discharged from the top side discharge hole 203l flows downward toward the bottom end along the incline of the linkage 203k in contact with the downwardly inclined exterior surface of the linkage 203k of the aspirating nozzle 203d. Therefore, the washing liquid discharged from the bottom side discharge hole 203m to the first barrel 203h flows to the bottom end of the aspirating nozzle 203d along the exterior surface of the aspirating nozzle 203d (first barrel 203h) and conjoins the flow of downwardly flowing washing liquid from the higher linkage 203k. In this way the washing liquid discharged by the two side discharge holes 203l and 203m toward the aspirating nozzle 203d flows along the exterior surface of the aspirating nozzle 203d.

In the second embodiment, the exterior surface of the linkage 203k (aspirating nozzle 203d) is inclined with a uniform gradient across the entire surface by tapering the linkage 203k of the aspirating nozzle 203d. Therefore, in the second embodiment the washing liquid discharged from the side discharge hole 203l forms a flow P around the exterior surface of the linkage 203k along the incline of the tapered linkage 203k, as shown in FIG. 27. In this way the washing liquid discharged from the side discharge hole 203l flows around to the back side of the aspirating nozzle 203d (first barrel 203h). In the second embodiment, the entire exterior circumference of the first barrel 203h of the aspirating nozzle 203d can thus be washed simply by discharging the washing liquid from one side (the side with the side discharge hole 203l) of the aspirating nozzle 203d.

Note that the aspects of the structure other than those described above in the second embodiment are identical to the structures of the first embodiment.

In the second embodiment described above, a jet nozzle 203e provided with side discharge holes 203l and 203m for discharging washing liquid is disposed facing the exterior surface of the aspirating nozzle 203d, and a syringe pump 103v is provided for supplying washing liquid to the exterior surface of the aspirating nozzle 203d via the side discharge holes 203l and 203m. In this way the exterior surface of the aspirating nozzle 203d is more effectively washed because a large amount of washing liquid can be reliably discharged on the exterior surface of the aspirating nozzle 203d.

In the second embodiment described above, side discharge holes 203l and 203m are provided at positions corresponding to the exterior surface of the aspirating nozzle 203d of the side surface of the jet nozzle 203e. In this way the jet nozzle 203e can be provided with discharge holes facing the exterior surface of the aspirating nozzle 203d via a simple structure. The exterior surface of the aspirating nozzle 203d is also effectively washed since the washing liquid is laterally aimed at the aspirating nozzle 203d by the side discharge holes 203l and 203m corresponding to the exterior surface of the aspirating nozzle 203d.

In the second embodiment described above, washing liquid is discharged not only from the side discharge hole 203l (203m) but also from the bottom discharge hole 203n by providing the bottom discharge hole 203n to discharge washing liquid at the bottom of the jet nozzle 203e. Therefore, the speed of the flowing washing liquid can be maintained at a constant level to maintain delivery of the amount of washing liquid using the small diameter (external diameter A3) jet nozzle 203e by providing the bottom discharge hole 203n and side discharge hole 203l (203m) and reducing the washing liquid discharge pressure by increasing the area of the opening of the discharge hole (side discharge holes 203l, 203m, and bottom discharge hole 203n). In this way the exterior surface of the aspirating nozzle 203d is more effectively washed while suppressing dispersion outside the cuvette 7 caused by rebounding of the discharged washing liquid against the against the exterior surface of the aspirating nozzle 203d even when using the small diameter jet nozzle 203e. Interference of the jet nozzle 203e and aspirating nozzle 203d with the cuvette 7 when inserted in the cuvette 7 is better suppressed when washing liquid is discharged into the cuvette 7 (refer to FIG. 26) and when unnecessary component is aspirated from the cuvette 7 because the external diameter measurements of the entirety of the aspirating nozzle 203d and jet nozzle 203e (total of the external diameter A2 of the second barrel 203j, external diameter A3 of the jet nozzle 203e) are reduced when using the small diameter jet nozzle 203e. In this way unnecessary component can be easily aspirated and the aspirating nozzle 203d can be easily washed.

In the second embodiment described above, the size of the opening of the side discharge holes 203l (203m) of the jet nozzle 203e is larger than the opening of the bottom discharge hole 203n. In this way a greater amount of washing liquid can be discharged from the side discharge holes 203l and 203m than from the bottom discharge hole 203n. Therefore, there is a reduction of the flow speed of the washing liquid discharged from the bottom discharge hole 203n. In this way it is possible to suppress rebounding of the washing liquid discharged from the bottom discharge hole 203n against the wall of the cuvette 7 resulting in dispersion of the washing liquid outside the cuvette 7 that is caused by an increase in the flow speed of the washing liquid when the amount of washing liquid is increased and when using the small diameter jet nozzle 203e.

In the second embodiment described above, the jet nozzle 203e is provided with two side discharge holes 203l and 203m, and the two side discharge holes 203l and 203m are disposed with a distance D therebetween along the longitudinal direction (vertical direction) of the jet nozzle 203e. In this way the flow speed of the washing liquid can be maintained below a constant level even when the amount of delivered washing liquid increases because the total area of the opening of the side discharge holes 203l and 203m can be increased by providing the two side discharge holes 203l and 203m. The exterior surface of the aspirating nozzle 203d is therefore washed more efficiently while suppressing dispersion of the washing liquid outside the cuvette 7 due to rebounding of the washing liquid discharged onto the exterior surface of the aspirating nozzle 203d. Furthermore, there is less reduction of the mechanical strength of the jet nozzle 203e by providing the two side discharge holes 203l and 203m at a mutually spaced distance D compared to when a single large side discharge hole is provided.

In the second embodiment described above, the mechanical strength of the aspirating nozzle 203d is improved by providing the second barrel 203j which has a larger external diameter than the first barrel 203h at the top end of the aspirating nozzle 203d. The external diameter measurements of the entirety of the aspirating nozzle 203d and jet nozzle 203e in the longitudinal direction (total width of the external diameter A2 of the second barrel 203j, external diameter A3 of the jet nozzle 203e) are reduced even when the jet nozzle 203e is separated from the aspirating nozzle 203d by placing the jet nozzle 203e adjacent to the second barrel 203j. As a result, the mechanical strength of the aspirating nozzle 203d is improved while suppressing an increase in the external diameter measurement in the longitudinal direction of the aspirating nozzle 203d and jet nozzle 203e.

In the second embodiment described above, the washing liquid is discharged from the side toward the inclined surface (exterior surface) formed by the linkage 203k which has a decreasing external diameter from the top toward the bottom. In this way the washing liquid discharged on the linkage 203k flows downward along the inclined exterior surface of the linkage 203k. The washing liquid flowing across the exterior surface of the aspirating nozzle 203d easily turns to the back side of the aspirating nozzle 203d (the opposite side from the side provided with the side discharge hole 203l) compared to when the washing liquid is discharged perpendicularly from the side relative to an external surface of uniform external diameter due to the flow characteristics because the washing liquid discharged from the side falls downward as it contacts the incline of the linkage 203k since the washing liquid is discharged from the side relative to the linkage 203k which is inclined so as to have a decreasing external diameter from the top to the bottom. In this way the external surface of the aspirating nozzle 203d is more effectively washed while suppressing rebounding of the washing liquid on the surface of the aspirating nozzle 203d. In particular, in the second embodiment, the entirety of the exterior surface of the first barrel 203h of the aspirating nozzle 203d is washed just by discharging the washing liquid from one side of the aspirating nozzle 203d because the enveloping washing liquid flow P is formed on the back side (the opposite side from the side provided with the discharge hole 203l) of the linkage 203k (aspirating nozzle 203d) by tapering the entire surface of the linkage 203k with a uniform gradient.

In the second embodiment described above, the amount of delivered washing liquid discharged from the side of the jet nozzle 203e can be increased by providing, in addition to the side discharge holes 203l, a side discharge hole 203m for discharging washing liquid on the exterior surface of the first barrel 203h. In this case, an increased amount of washing liquid can flow on the exterior surface of the aspirating nozzle when washing liquid is discharged from the side discharge hole 203m toward the inclined surface (linkage 203k) because the washing liquid discharged from the side discharge hole 203m onto the exterior surface of the first barrel 203h flows on the exterior surface of the aspirating nozzle 203d so as to conjoin with the washing liquid flowing downward from the top of the linkage 203k (washing liquid discharged from the side discharge hole 203l).

Note that the embodiments of the present disclosure are in all aspects simply examples and should not in any way be construed as limiting. The scope of the present invention is defined by the scope of the claims and not be the description of the embodiment, and includes all modifications within the scope of the claims and the meanings and equivalences therein.

For example, the first embodiment is described by way of example in which the bottom endface of the bottom member is inclined from the exterior surface of the bottom member to the center axis of the nozzle member so that the side nearest the nozzle member 103d is positioned on the upstream side of the washing liquid flow and the side farthest from the nozzle member 103d is positioned on the downstream side of the washing liquid flow; however, the present invention is not limited to this arrangement. The bottom endface of the bottom member may also have a shape other than the inclined shape insofar as the washing liquid can be reliably discharged onto the exterior surface of the nozzle member.

Although the first embodiment is described by way of example in which a structure has a plurality of mutually adhered tubular members, the present invention is not limited to this arrangement. The plurality of tubular members need not be mutually adhered and may be disposed with a predetermined spacing therebetween insofar as the washing liquid can be uniformly discharged toward the exterior surface of the nozzle member.

Although the first embodiment is described by way of example in which the jet member is cylindrical with the same center axis as the nozzle member, the present invention is not limited to this arrangement. The jet member need not be cylindrical with the same center axis as the nozzle member insofar as the washing liquid can be uniformly discharged toward the exterior surface of the nozzle member. The jet member may also be a rectangular shape.

Although the first embodiment is described by way of example in which the seal member is made of epoxy resin, the present invention is not limited to this arrangement inasmuch as the seal member may also be made of non-epoxy resin, such as silicone rubber (resin) and the like.

Although the first embodiment is described by way of example in which washing liquid discharged from a plurality of discharge holes of a jet member strikes the exterior surface of the nozzle part of a nozzle member, the present invention is not limited to this arrangement. In the structure of the first embodiment, a linkage with an external diameter tapered toward the bottom end may be provided in a region of the exterior surface of the nozzle member which is struck by the washing liquid discharged from the discharge hole. In this case, the washing liquid easily flows toward the bottom end.

Although the second embodiment is described by way of example in which two side discharge holes are provided on the jet nozzle, the present invention is not limited to this number inasmuch as three or more side discharge holes may also be provided. In this case, it is desirable to position the side discharge holes at a mutual spacing so as to not reduce the mechanical strength of the jet nozzle. Moreover, a single side discharge hole may also be provided. In this case, it is desirable to set the size of the side discharge hole to a size that will not reduce the mechanical strength of the jet nozzle.

Although the second embodiment is described by way of example in which two side discharge holes are disposed linearly with a spacing therebetween along the longitudinal direction of the jet nozzle, the present invention is not limited to this arrangement. The side discharge holes also need not be disposed linearly with spacing along the longitudinal direction of the jet nozzle.

Although the second embodiment is described by way of example in which a single jet nozzle is provided, the present invention is not limited to this number inasmuch as two or more jet nozzles may also be provided along the longitudinal direction of the aspirating nozzle.

Although the second embodiment is described by way of example in which the side discharge holes of the jet nozzle face a direction orthogonal to the longitudinal direction of the jet nozzle and facing the exterior surface of the aspirating nozzle, the present invention is not limited to this arrangement. The side discharge hole may also be provided facing the exterior surface of the aspirating nozzle and inclined toward the bottom end of the aspirating nozzle. In this case, the washing liquid easily flows in the direction of the bottom end of the aspirating nozzle even if the washing liquid does not strike the tapered linkage since the washing liquid discharged from the side discharge hole flows inclined in the direction of the bottom end of the aspirating nozzle. In this way the exterior surface of the aspirating nozzle can be effectively washed.

Although the second embodiment is described by way of example in which a bottom discharge hole for discharging washing liquid downward is provided at the bottom end of the jet nozzle, the present invention is not limited to this arrangement inasmuch as the bottom discharge hole need not be provided at the bottom end of the jet nozzle. The bottom discharge hole may also be formed so as to face the side of the aspirating nozzle by bending the bottom end of the jet nozzle to the aspirating nozzle side.

Although the second embodiment is described by way of example in which the linkage is tapered in the shape of a reverse truncated cone which is inclined at an angle α1 symmetrical to the center axis. The linkage may also be inclined asymmetrically relative to the center axis. The linkage may also have a curved cross section which is either concave or convex so that the external diameter decreases toward the first barrel. The linkage may also be tapered at an angle other than angle α1. The linkage may also have a continuous external diameter toward the first barrel.

Although the second embodiment is described by way of example in which the jet nozzle is adjacent to the second barrel of the aspirating nozzle, the present invention is not limited to this arrangement inasmuch as the jet nozzle may also be separated from the aspirating nozzle.

Although the second embodiment is described by way of example in which the top side discharge hole (side discharge hole 203l) of the jet nozzle faced the linkage of the aspirating nozzle and the bottom side discharge hole (side discharge hole 203m) faces the first barrel, the present invention is not limited to this arrangement. The linkage may be longer in the longitudinal direction of the aspirating nozzle so that the washing liquid is also discharged toward the linkage from the bottom side discharge hole. The entirety of the first barrel may also be tapered toward the bottom end.

Although the second embodiment is described by way of example in which the top side discharge hole of the jet nozzle faces a region of the linkage between a position a distance L1 from the tip of the aspirating nozzle and a position a distance L2 from the tip of the aspirating nozzle, the present invention is not limited to this arrangement. The side discharge hole may also be provided somewhat above the top end of the linkage (a position a distance L2 from the top of the aspirating nozzle. The side discharge hole may also be provided at a position where the washing liquid from the side discharge hole substantially strikes the inclined exterior surface of the linkage. In this case, part of the washing liquid discharge flow from the side discharge hole strikes the exterior surface of the second barrel while the majority of the washing liquid from the side discharge hole strikes the linkage.

Although the second embodiment is described by way of example in which the bottom side discharge hole (side discharge hole 203m) of the jet nozzle corresponds to the exterior surface of the first barrel of the aspirating nozzle, the present invention is not limited to this arrangement. The side discharge hole may also be provided above the top end of the first barrel (position a distance L2 from the tip of the aspirating nozzle). In this case, part of the washing liquid discharge flow from the side discharge hole strikes the exterior surface of the linkage while the majority of the washing liquid from the side discharge hole strikes the first barrel.

Although the first embodiment is described by way of example in which the discharge hole at the bottom end of the nozzle member is circular and the second embodiment is described by way of example in which the bottom discharge hole is circular, the present invention is not limited to this arrangement. The discharge hole need not be circular inasmuch as the discharge hole may also be, for example, hexagonal or square.

Although the first and second embodiments are described by way of examples in which the present invention is applied to an aspirating mechanism for aspirating unnecessary component in a cuvette, the present invention is not limited to this application. For example, the present invention may also be applied to a reagent aspirating mechanism for aspirating reagent in a reagent container, and a sample aspirating mechanism for aspirating sample in a test tube.

Although the first embodiment is described by way of example in which the nozzle member is made of stainless steel and the second embodiment is described by way of example in which the both the aspirating nozzle and the jet nozzle are made of stainless steel, the present invention is not limited to this arrangement. For example, the nozzle member (aspirating nozzle, jet nozzle) may also be made of PTFE Teflon (registered trademark) tubing. In this case the anticorrosion properties are improved and cost is reduced.

Although the first and second embodiments are described by way of examples in which a syringe pump is used as the washing liquid supplier, the present invention is not limited to this arrangement. For example, instead of a syringe pump, a diaphragm pump or other structure may also be used as the washing liquid supplier.

What is claimed is:

1. A liquid aspirating apparatus comprising:
a liquid aspirating nozzle;
an aspirator for aspirating liquid through the liquid aspirating nozzle;
a washing liquid discharging nozzle being arranged along a longitudinal direction of the liquid aspirating nozzle, wherein a discharge hole for discharging washing liquid is formed on the washing liquid discharging nozzle and the discharge hole faces a side surface of the liquid aspirating nozzle; and
a washing liquid supplier for supplying the washing liquid to the side surface of the liquid aspirating nozzle through the discharge hole of the washing liquid discharging nozzle.

2. The liquid aspirating apparatus of claim 1, wherein
the discharge hole is arranged at a position on a side surface of the washing liquid discharging nozzle, the position facing the side surface of the liquid aspirating nozzle.

3. The liquid aspirating apparatus of claim 2, wherein
a bottom discharge hole for discharging the washing liquid supplied from the washing liquid supplier downward from the washing liquid discharging nozzle is formed on a bottom end of the washing liquid discharging nozzle.

4. The liquid aspirating apparatus of claim 3, wherein
an opening of the discharge hole is larger than that of the bottom discharge hole.

5. The liquid aspirating apparatus of claim 2, wherein
a second discharge hole is formed at a position on the side surface of the washing liquid discharging nozzle and the second discharge hole faces the side surface of the liquid aspirating nozzle, the position facing the side surface of the liquid aspirating nozzle; and
the discharge hole and the second discharge hole are arranged in a longitudinal direction of the washing liquid discharging nozzle with a space therebetween.

6. The liquid aspirating apparatus of claim 2,
wherein the liquid aspirating nozzle comprises:
a first body part being positioned on the bottom end side of the liquid aspirating nozzle, an aspirating hole for aspirating liquid being formed on the first body;
a second body part being positioned at a top end side of the liquid aspirating nozzle, and having an external diameter greater than that of the first body; and
a connecting part connecting the first body part and the second body part, an external diameter of the connecting part continuously decreasing from the second body part to the first body part,
and wherein the discharge hole faces an side surface of the connecting part.

7. The liquid aspirating apparatus of claim 1,
wherein the liquid aspirating nozzle comprises:
a first body part being positioned on the bottom end side of the liquid aspirating nozzle, an aspirating hole for aspirating liquid being formed on the first body; and
a second body part being positioned at a top end side of the liquid aspirating nozzle, and having an external diameter greater than that of the first body,
and wherein the washing liquid discharging nozzle is arranged adjacent to the second body part of the liquid aspirating nozzle.

8. The liquid aspirating apparatus of claim 1, wherein
the discharge hole is inclined relative to the longitudinal direction of the liquid aspirating nozzle.

9. The liquid aspirating apparatus of claim 8, wherein
an undersurface of the washing liquid discharging nozzle comprises an inclined part which is inclined so that a side nearest the liquid aspirating nozzle is positioned on an upstream side of the washing liquid flow and a side farthest from the liquid aspirating nozzle is positioned on a downstream side of the washing liquid flow; and
the discharge hole is arranged at the inclined part.

10. The liquid aspirating apparatus of claim 8, wherein
a plurality of the washing liquid discharging nozzle are provided circularly along the longitudinal direction of the liquid aspirating nozzle.

11. The liquid aspirating apparatus of claim 10, wherein
the plurality of the washing liquid discharging nozzles are arranged in a mutually contacted state.

12. The liquid aspirating apparatus of claim 10, further comprising
a cylindrical part having a cylindrical shape with the same axis as a center axis of the liquid aspirating nozzle, and including the plurality of the washing liquid discharging nozzles.

13. The liquid aspirating apparatus of claim 12, wherein
the cylindrical part comprises:
a nozzle mounting part for mounting the plurality of the washing liquid discharging nozzles therein; and
a single flow channel part being connected to a top end of the nozzle mounting part, and comprising a single flow channel for leading the washing liquid supplied from the washing liquid supplier to each of the plurality of the washing liquid discharging nozzles in the nozzle mounting part.

14. The liquid aspirating apparatus of claim 1, wherein
the liquid aspirating nozzle comprises:
a nozzle part being arranged so as to extend in a vertical direction, an aspirating hole to be immersed in the liquid being formed on the nozzle part; and
an aspiration flow channel part being connected to a top end of the nozzle part, and comprising a curved channel which is curved so that a liquid flowing upward through the nozzle part flows downward.

15. The liquid aspirating apparatus of claim 12,
wherein the liquid aspirating nozzle comprises:
a nozzle part being arranged so as to extend in a vertical direction, an aspirating hole to be immersed in the liquid being formed on the nozzle part; and
an aspiration flow channel part being connected to a top end of the nozzle part, and comprising a curved channel which is curved so that a liquid flowing upward through the nozzle part flows downward,
wherein the curved channel extends from within the cylindrical part;
and wherein the liquid aspirating apparatus further comprises a resin seal member for sealing a gap between the curved channel and the cylindrical part.

16. The liquid aspirating apparatus of claim 15, wherein
the seal member mutually fastens the curved channel and the cylindrical part.

17. A sample analyzer comprising:
a sample aspirating apparatus for aspirating a sample in a container; and
an analyzing apparatus for analyzing a predetermined component in the sample in the container, using either the sample aspirated by the sample aspirating apparatus or the sample remaining in the container after aspiration by the sample aspirating apparatus, wherein
the sample aspirating apparatus comprises:
a liquid aspirating nozzle for aspirating the sample in the container;
an aspirator for aspirating the sample in the container through the liquid aspirating nozzle;
a washing liquid discharging nozzle being arranged along a longitudinal direction of the liquid aspirating nozzle, a discharge hole for discharging washing liquid being formed on the washing discharging nozzle and the discharge hole facing a side surface of the liquid aspirating nozzle; and
a washing liquid supplier for supplying the washing liquid to the side surface of the liquid aspirating nozzle through the discharge hole of the washing liquid discharging nozzle.

18. The sample analyzer of claim 17, wherein
the predetermined component is an antigen or an antibody.

19. The sample analyzer of claim 17, wherein
the discharge hole is arranged at a position on a side surface of the washing liquid discharging nozzle, the position facing the side surface of the liquid aspirating nozzle.

20. The sample analyzer of claim 17, wherein
the discharge hole is inclined relative to the longitudinal direction of the liquid aspirating nozzle.
